(19) United States
(12) Patent Application Publication
(10) Pub. No.: US 2025/0191489 A1
(43) Pub. Date: Jun. 12, 2025

(54) VIRTUAL REALITY SIMULATION AND METHOD

(71) Applicant: QUALITY EXECUTIVE PARTNERS, INC., Alexandria, VA (US)

(72) Inventors: Rebecca Brewer, Perkasie, PA (US); Tyler DeWitt, Crosslake, MN (US); Charleston Ford, Atlanta, GA (US); Thomas M. Freehill, Atlanta, GA (US); Kelly Lynch, Larchwood, IA (US); Katayoun Meyer, Broomfield, CO (US); Burton Posey, Avondale Estates, GA (US); Aries Reiss, Philadelphia, PA (US); Jacob B. Schwartz, Zionsville, IN (US); Jeremy Washington, Taylors, SC (US); Michael Williams, Cumming, GA (US); Brian Duncan, The Woodlands, TX (US); Crystal Mersh, Arnoldsburg, WV (US); Nicole Monachino, Alexandria, VA (US)

(21) Appl. No.: 18/846,455

(22) PCT Filed: Mar. 22, 2023
(86) PCT No.: PCT/US2023/015919

§ 371 Date: Sep. 12, 2024

Related U.S. Application Data
(60) Provisional application No. 63/322,286, filed on Mar. 22, 2022.

(51) Int. Cl. G09B 9/00; G06F 3/01; G06F 3/0346; G06F 3/04815

(52) U.S. Cl. CPC G09B 9/00; G06F 3/012; G06F 3/016; G06F 3/0346; G06F 3/04815

(57) ABSTRACT

One aspect of the present disclosure include a method and system for providing an interactive virtual reality simulation for virtual reality training. A headset, controllers, and/or one or more sensors communicate with a processor to display the interactive virtual reality simulation on a user display within the headset. The interactive virtual reality training for use in facilitating virtually reality simulations including a micropipette simulation, and a centrifuge simulation.

### CROSS REFERENCES TO RELATED APPLICATIONS

The following application claims priority under 35 U.S.C. § 119 (e) to U.S. Provisional Patent Application Ser. No. 63/322,286 filed Mar. 22, 2022 entitled VIRTUAL REALITY SIMULATION AND METHOD. Priority is claimed for all the above-identified applications and publication, all of which are incorporated herein by reference in their entireties for all purposes.

### TECHNICAL FIELD

The present disclosure generally relates to an apparatus and methods for virtual reality training, and more particularly to methods and devices utilizing a processor device, visual outputs, sensor devices and special sensors combination for use in facilitating virtual reality simulations including a micropipette simulation, a multi-channel micropipette simulation and/or a centrifuge simulation.

### BACKGROUND

Training for laboratory situations, such as using a micropipette, a multi tip micropipette simulation and/or balancing a centrifuge, is required for most workers in a laboratory and/or manufacturing environment. Real-world training can be time consuming, expensive (e.g., centrifuges can be damaged by improper use), and/or risky if students make mistakes on real products and quantities or concentrations of active ingredients are incorrect, and/or contaminated samples from improper micropipette use get sent to hospitals and/or are used on patients. Further, in the real-world specific elements cannot be emphasized, or altered to better ingrain training. This is particularly the case for training that requires extensive laboratory training time for various certification or degreed programs. Such training is both expensive in capital equipment, as well as requiring tear down, cleaning, and set-up costs. Such laboratory training issues are discussed in Pat. Pub. No. WO/2020/123026 to Mersh et al., which is assigned to the assignee of the present disclosure and is incorporated herein by reference.

### SUMMARY

One aspect of the present disclosure comprises a non-transitory computer readable medium storing instructions executable by an associated processor to perform a method for implementing a micropipette simulation. The method includes generating a three-dimensional initial view comprising a micropipette and one or more micropipette tips based upon a view selection input by a user, sending instructions to present the initial view to a user display of a headset, the user display comprised within the headset, and receiving an input from a controller comprising at least one sensor indicating user movement within the initial view. The method further includes responsive to the micropipette being coupled to the controller, assigning the controller a designation of micropipette hand, coupling a micropipette tip of the one or more micropipette tips to the micropipette, and responsive to a tip activation volume of the micropipette tip interacting with a container activation volume of a container housing a liquid, and a tactile element on the controller of the micropipette hand being actuated presenting movement of a plunger of the micropipette from a first stop to a resting position and simultaneously generating instructions to display a continuous liquid transfer from the container to the micropipette tip, wherein the speed of the continuous transfer is proportional to a speed of an actuation of the tactile element.

Another aspect of the present disclosure comprises a virtual reality system for providing a multichannel pipette simulation. The system comprises a processing device having a processor configured to perform a predefined set of operations in response to receiving a corresponding input from at least one of a virtual reality headset and at least one controller, the processing device comprising memory, wherein a three-dimensional initial view of a multichannel pipette simulation is stored, the initial view comprising at least one multichannel pipette supporting at least two barrels, and a tip box supporting two or more tips. The system comprises wherein the processor instructs the initial view to be presented on a user display comprised within the headset, the at least one controller sends an input to the processor indicating the controller is moving within the initial view, the processor instructs the movement of the controller of the at least one controller be presented on the user display, and responsive to an input from the controller, the processor assigns the multichannel pipette be controlled by movement of the controller and designates said controller as the pipette hand. The system comprises wherein the processor assigns a micropipette axis extending parallel to and intersecting the two or more barrels of the multichannel pipette, the processor assigns an alignment axis extending parallel to and intersecting the two or more tips to the tip box, and responsive to the controller indicating that a tip activation volume of the multichannel micropipette is within a tip box interaction volume assigned to the tip box, the processor determines a percent deviation from a y axis alignment threshold, wherein the y-axis alignment threshold a deviation over a y axis angle of the micropipette axis from the alignment axis along a y direction. The system additionally comprises wherein responsive to the tip activation volume being within the y axis alignment threshold, the processor generates an image of the two or more tips attached to the two or more barrels.

Yet another aspect of the present disclosure includes a non-transitory computer readable medium storing instructions executable by an associated processor to perform a method for implementing a centrifuge simulation. The centrifuge simulation comprises generating a three-dimensional initial view comprising a centrifuge and one or more centrifuge tubes based upon a view selection input by a user, sending instructions to present the initial view to a user display of a headset, the user display comprised within the headset, receiving an input from a controller comprising at least one sensor indicating user movement within the initial view, and assigning a plurality of centrifuge loading activation volumes to a plurality of tube racks housed within the centrifuge. The method further comprises responsive to the controller entering an assigned centrifuge tube activation area, assigning the controller a designation of centrifuge tube hand, responsive to the centrifuge tube hand entering a first centrifuge loading activation volume of the plurality of centrifuge loading activation volumes, generating an image of the centrifuge tube residing within the tube rack assigned to the first centrifuge loading activation volume, and responsive to the centrifuge tube hand coupled to a second centrifuge tube entering a second centrifuge loading activation volume of the plurality of centrifuge loading activation volumes, generating an image of the centrifuge tube residing within the tube rack assigned to the second centrifuge loading activation volume. The method additionally includes identifying a state of the centrifuge tubes, wherein responsive to the centrifuge tubes being in a balanced state, wherein the balanced state comprises wherein the centrifuge tubes act as counter weights to each other within the tube racks, allowing the centrifuge to be actuated into rotation.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 illustrates an example virtual reality system, according to one example embodiment of the present disclosure;

FIG. 2 is a schematic diagram of a method of using an example virtual reality system, according to one example embodiment of the present disclosure;

FIG. 3A illustrates a micropipette simulation generated by an example virtual reality system, according to one example embodiment of the present disclosure;

FIG. 3B illustrates a micropipette simulation schematic diagram, according to one example embodiment of the present disclosure;

FIG. 3C illustrates a micropipette simulation activation volume generated by an example virtual reality system, according to one example embodiment of the present disclosure;

FIG. 3D illustrates a micropipette with multiple activation volumes generated by an example virtual reality system, according to one example embodiment of the present disclosure;

FIG. 3E illustrates a tip box and tip box activation volume generated by an example virtual reality system, according to one example embodiment of the present disclosure;

FIG. 3F illustrates an open tip box generated by an example virtual reality system, according to one example embodiment of the present disclosure;

FIG. 3G illustrates an open tip box and open tip box activation volume generated by an example virtual reality system, according to one example embodiment of the present disclosure;

FIG. 3H illustrates a micropipette interacting with an incorrect tip generated by an example virtual reality system, according to one example embodiment of the present disclosure;

FIG. 3I illustrates an open tip box and a micropipette interacting therewith generated by an example virtual reality system, according to one example embodiment of the present disclosure;

FIG. 3J illustrates a closed tip box generated by an example virtual reality system, according to one example embodiment of the present disclosure;

FIG. 3K illustrates a micropipette with a tip generated by an example virtual reality system, according to one example embodiment of the present disclosure;

FIG. 3L illustrates a micropipette with a tip and a non-micropipette hand generated by an example virtual reality system, according to one example embodiment of the present disclosure;

FIG. 3M illustrates a magnified view of a micropipette with a tip from FIG. 3K generated by an example virtual reality system, according to one example embodiment of the present disclosure;

FIG. 3N illustrates a micropipette with a tip and a non-micropipette hand interacting with a container generated by an example virtual reality system, according to one example embodiment of the present disclosure;

FIG. 30 illustrates a container having a cap interaction volume generated by an example virtual reality system, according to one example embodiment of the present disclosure;

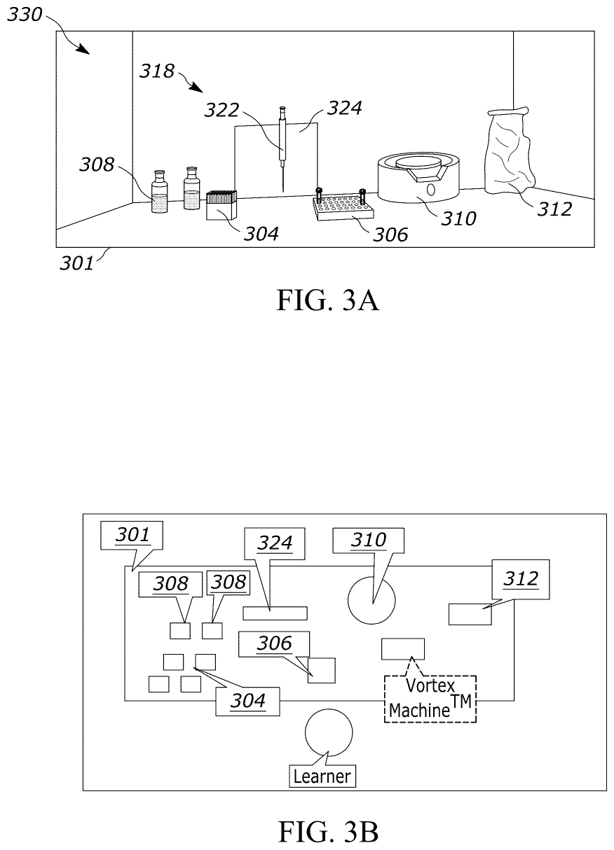

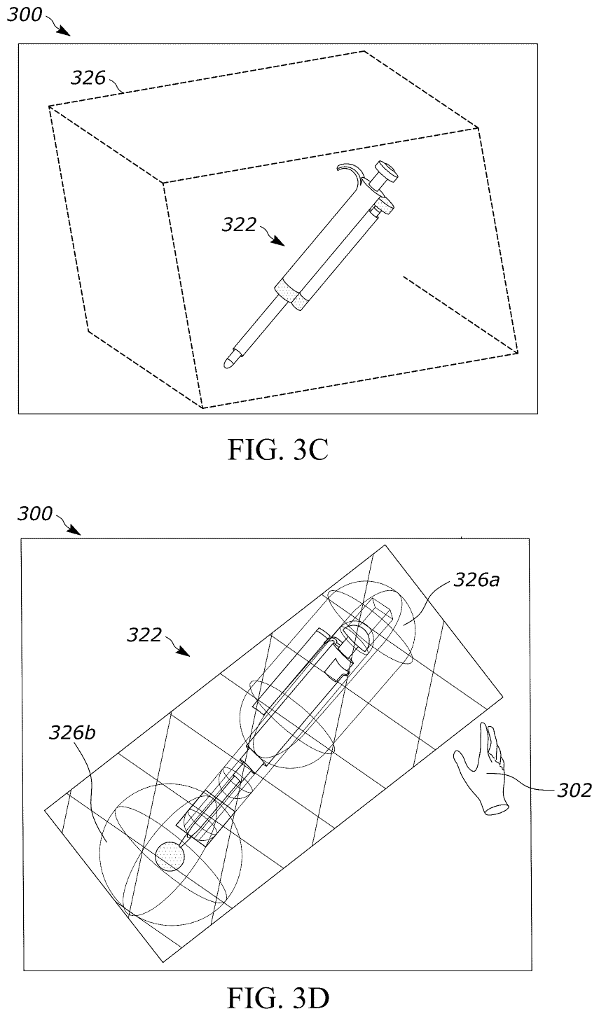

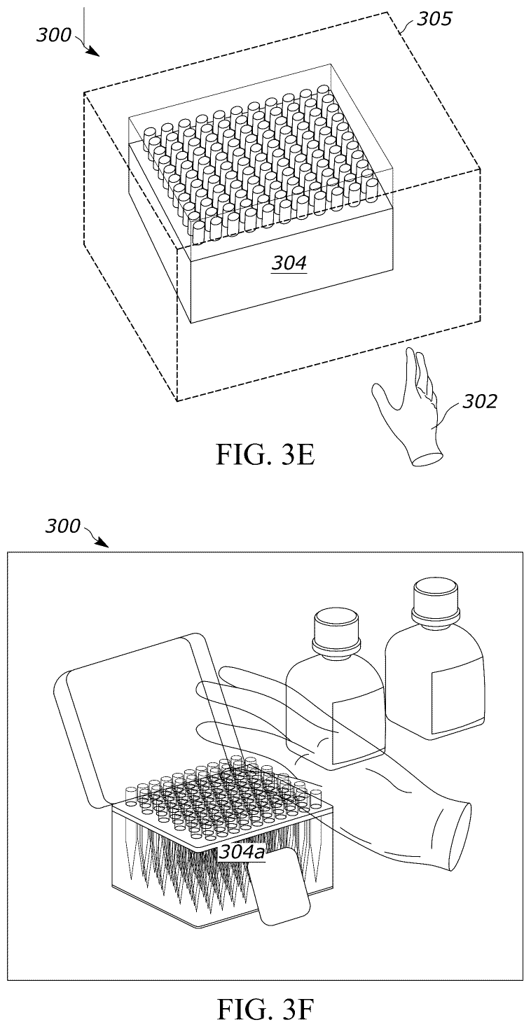

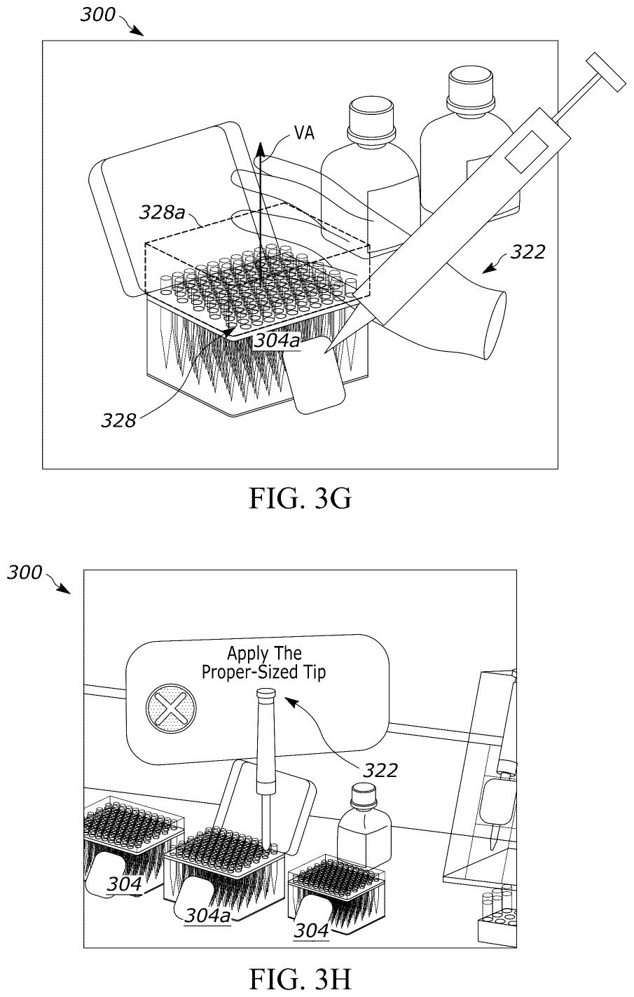

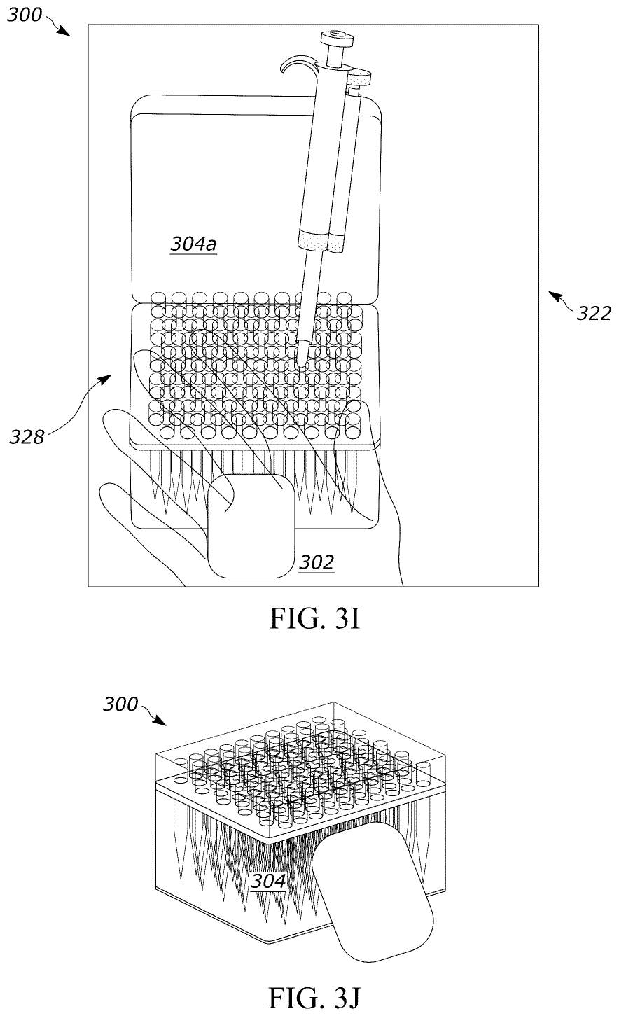

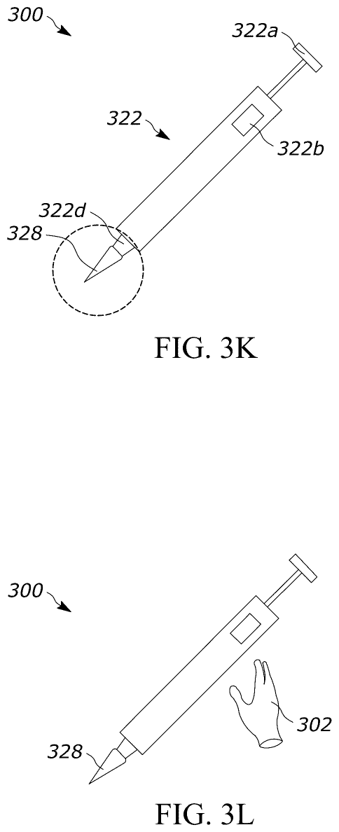

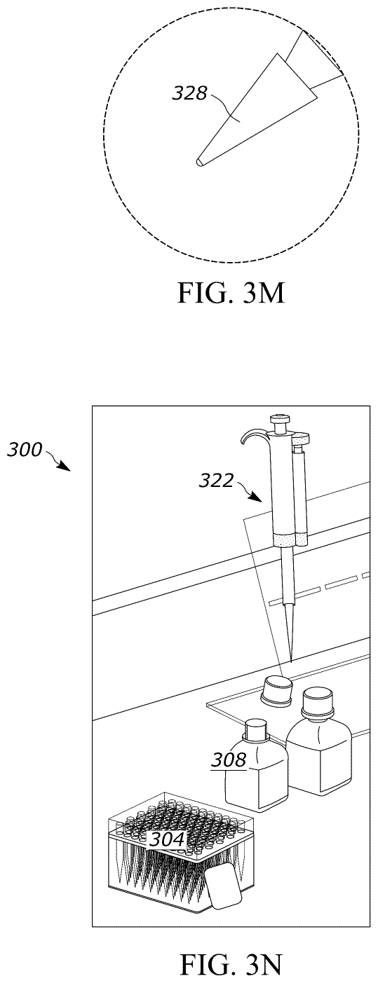

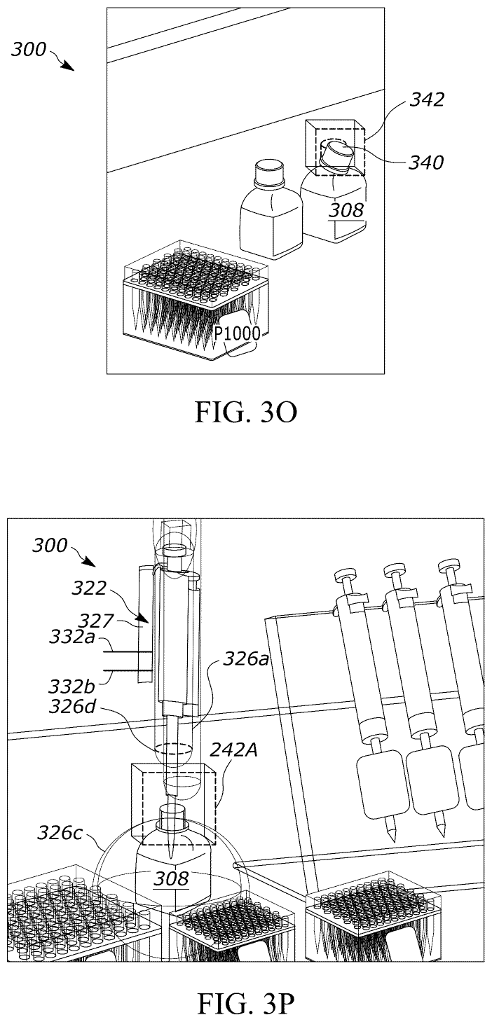

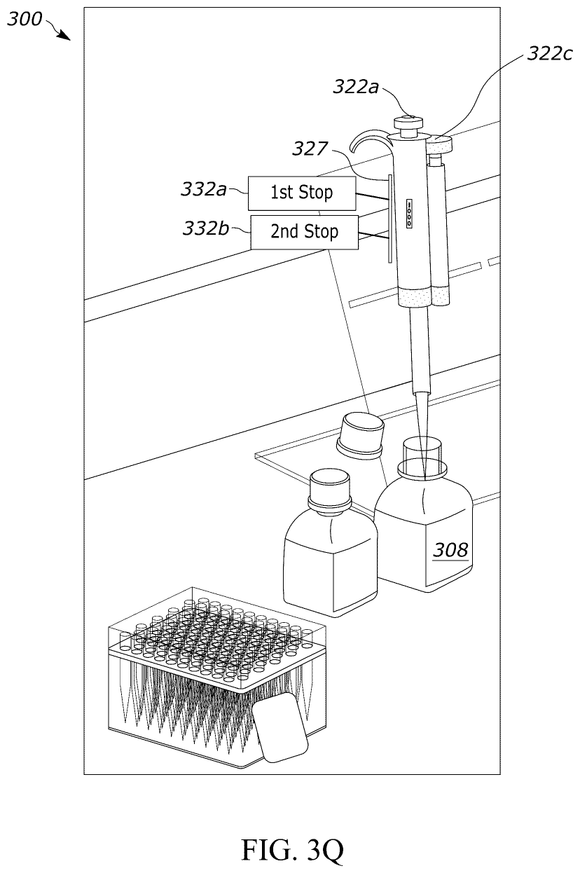

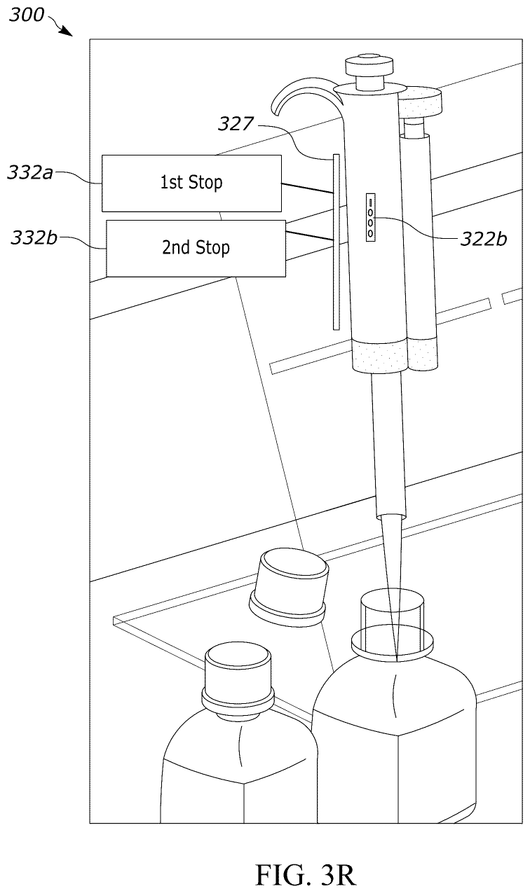

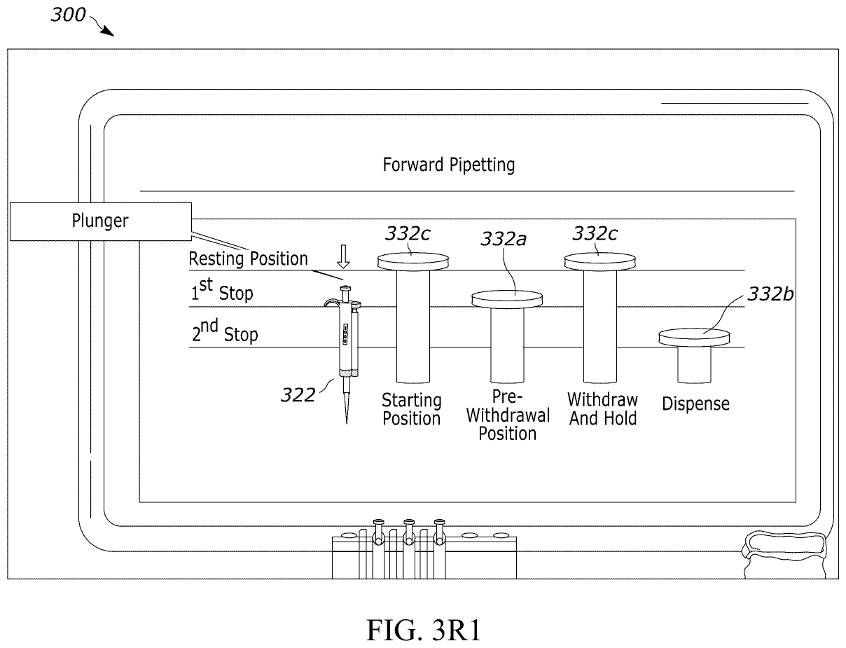

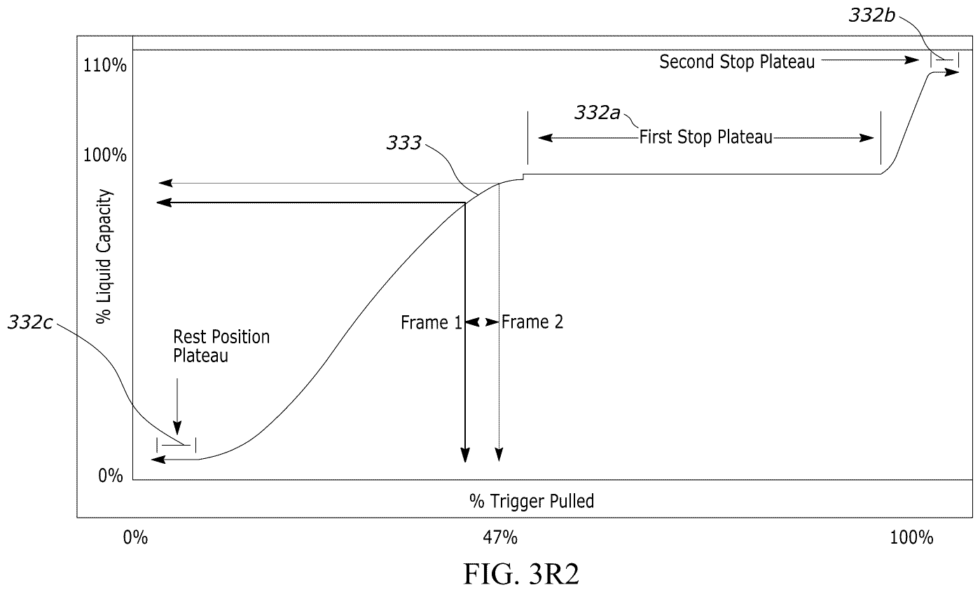

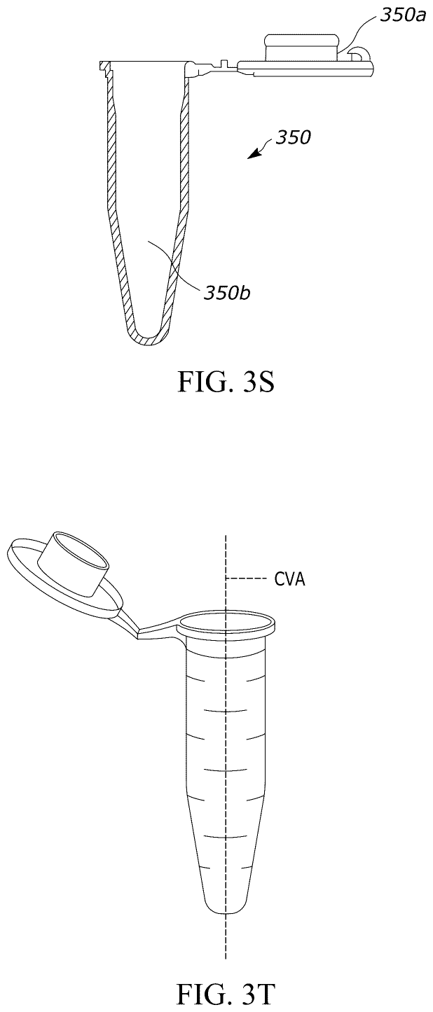

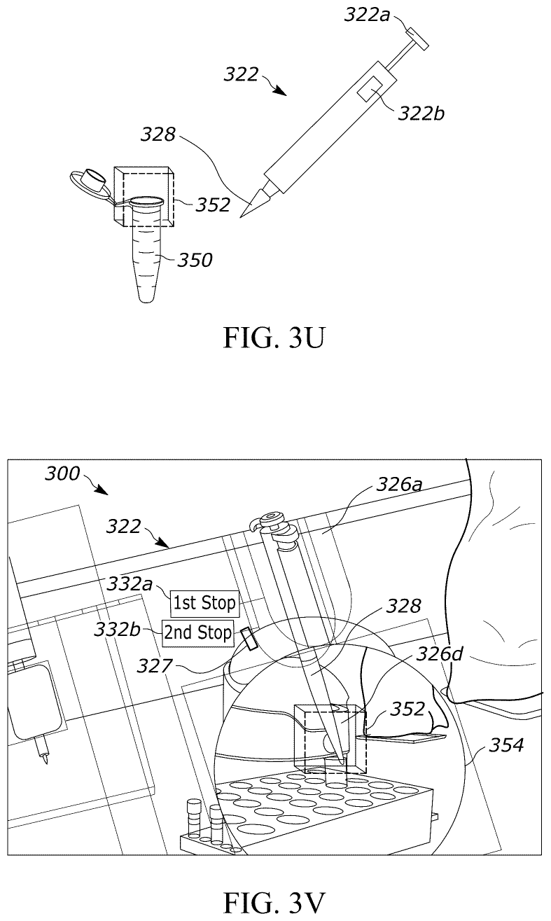

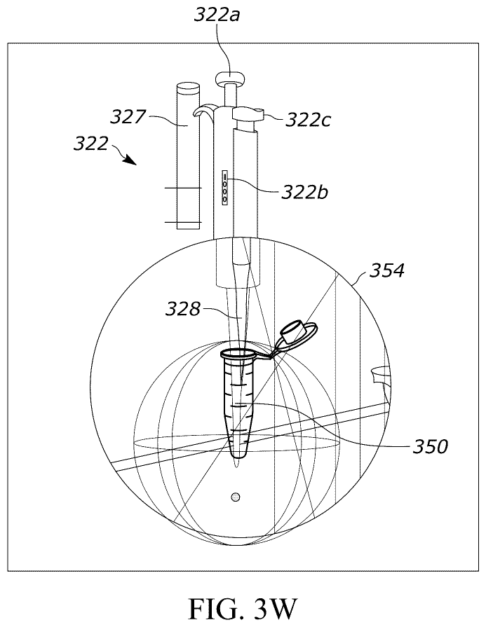

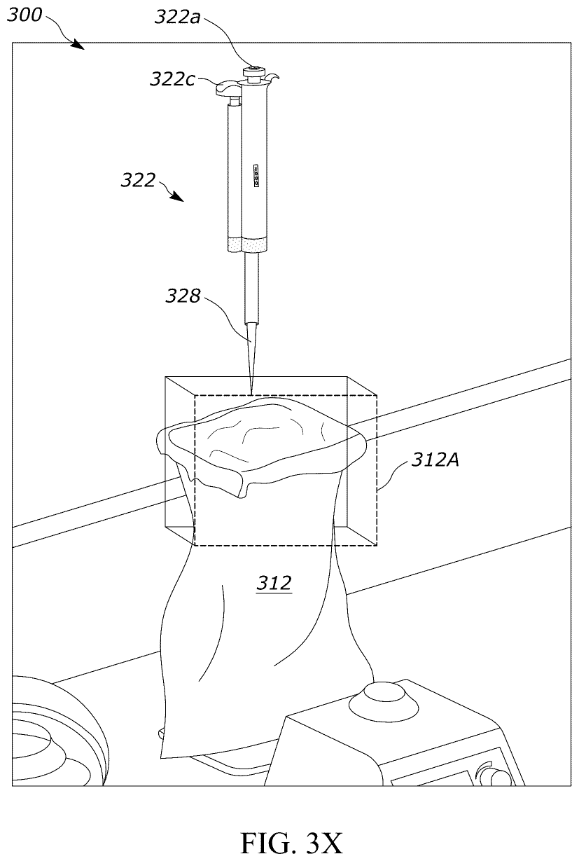

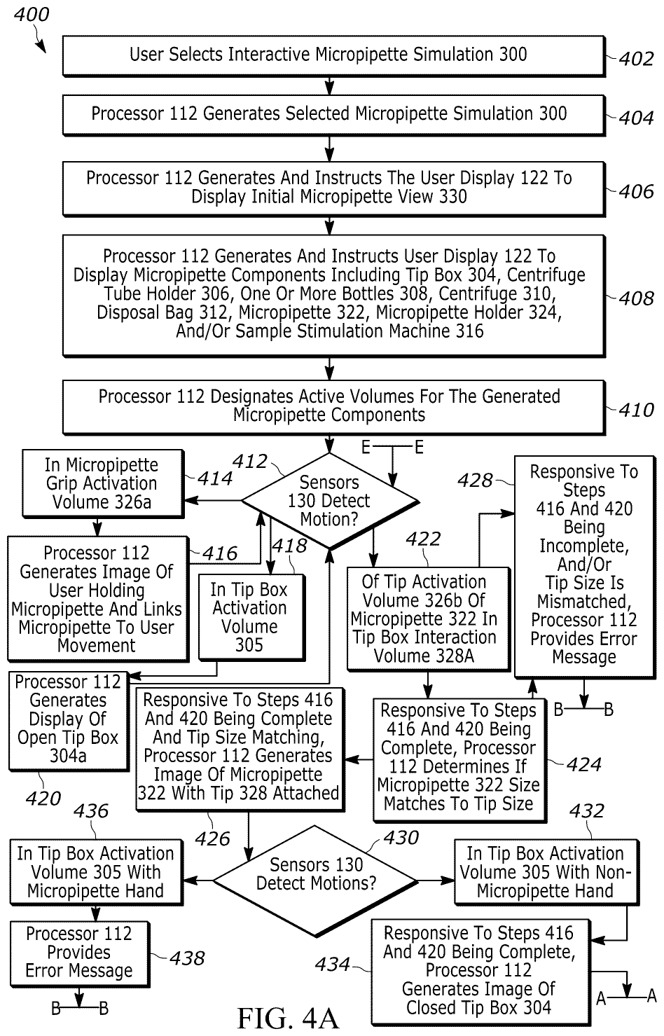

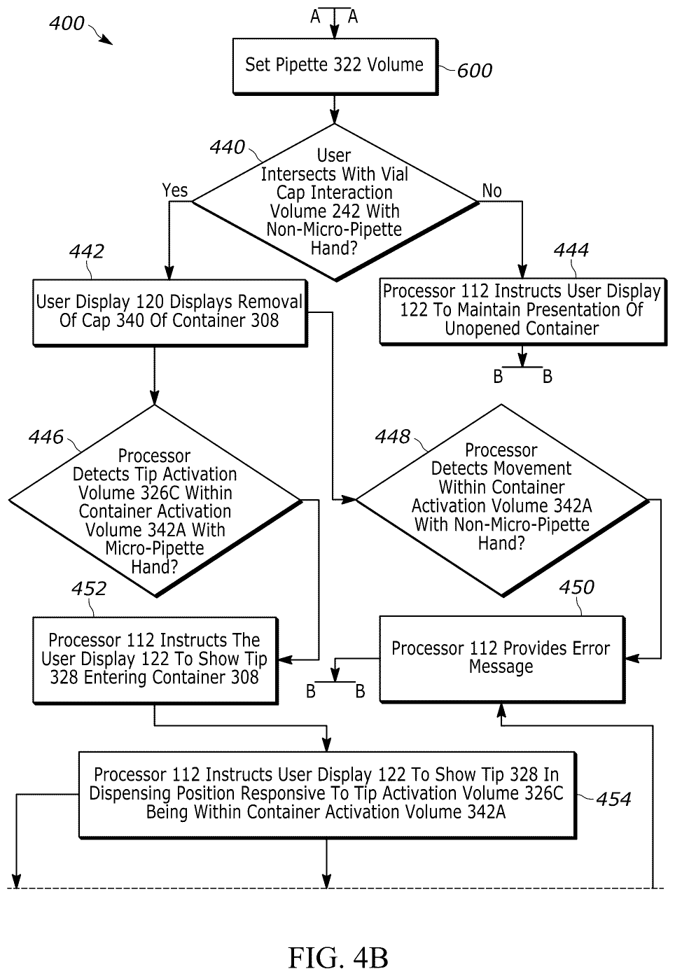

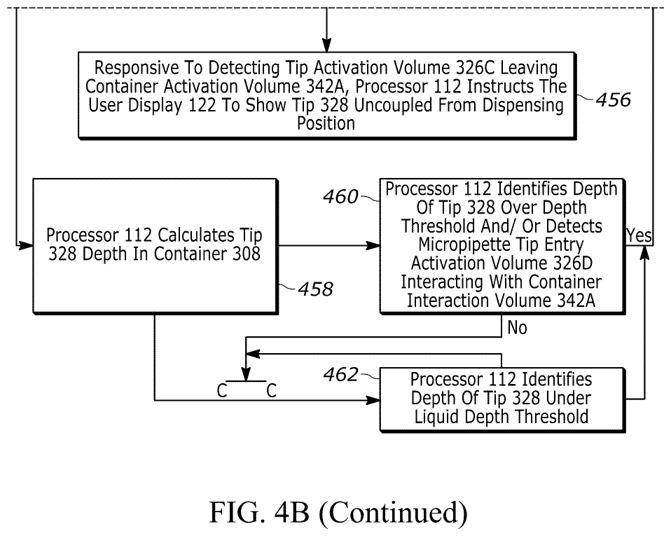

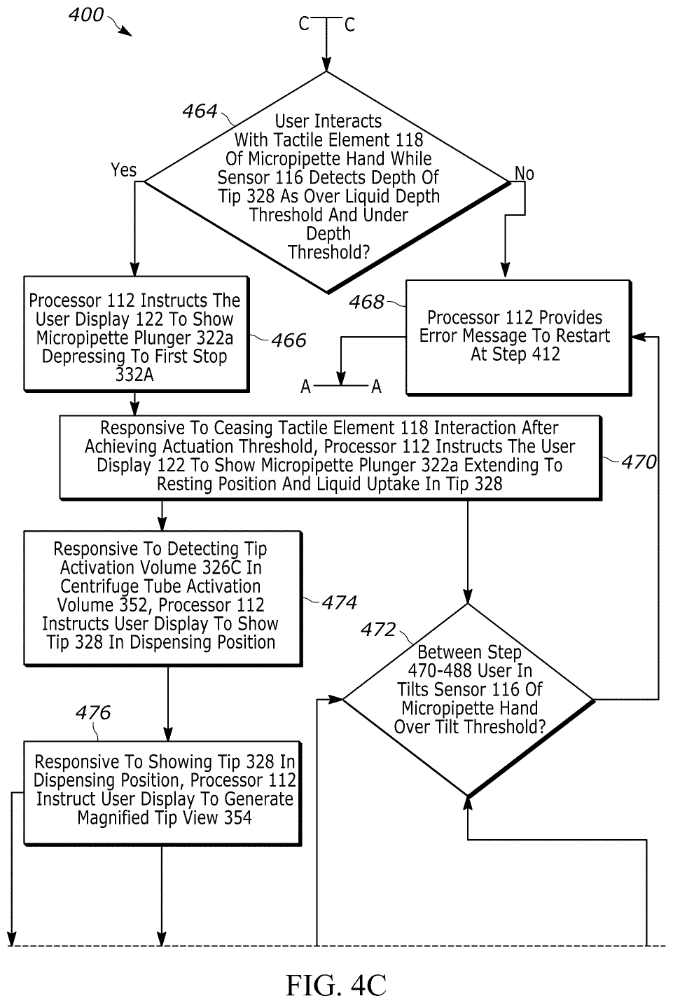

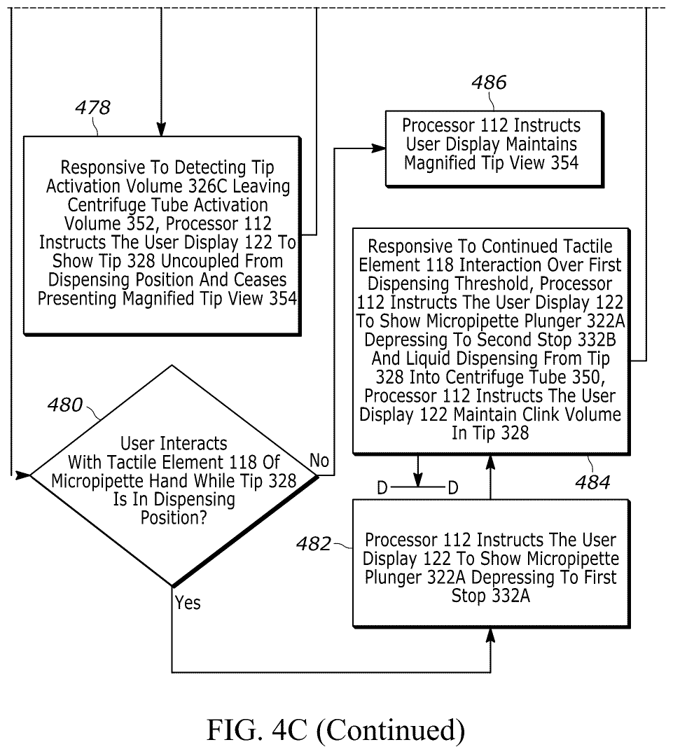

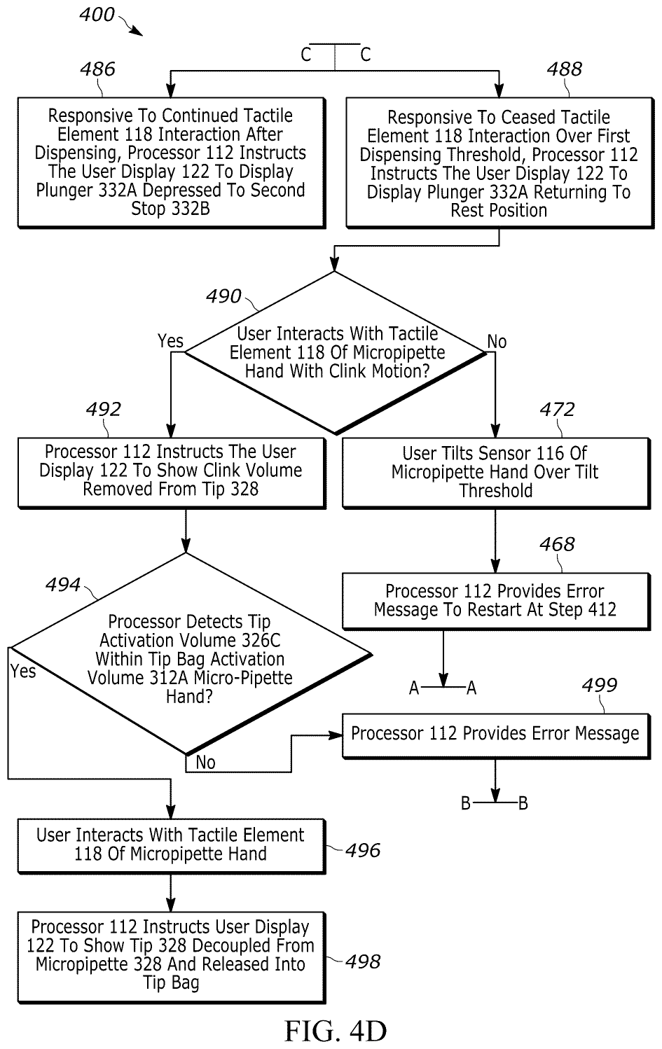

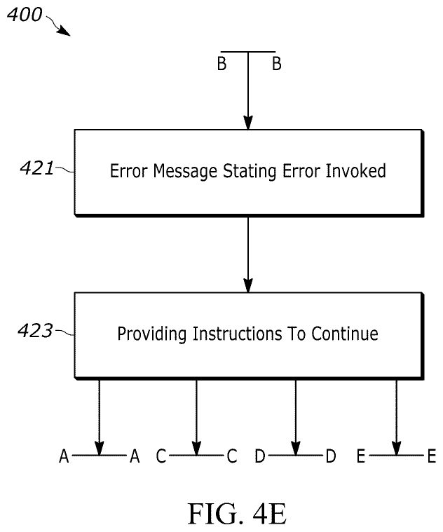

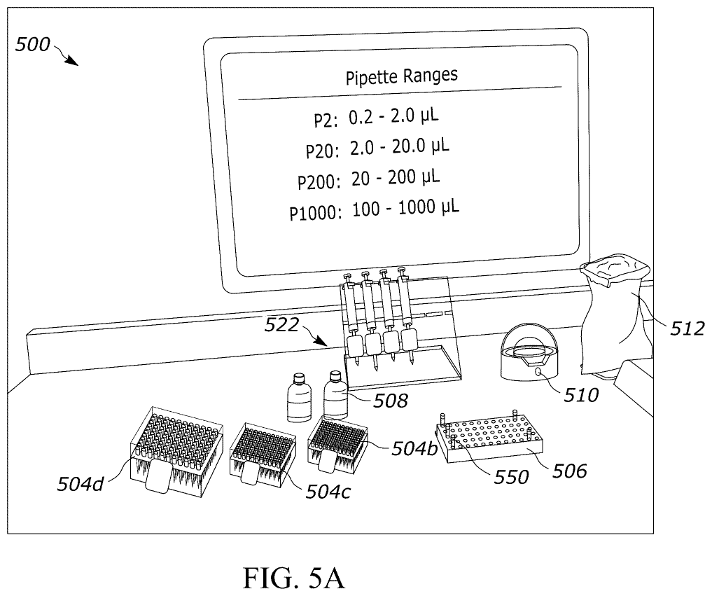

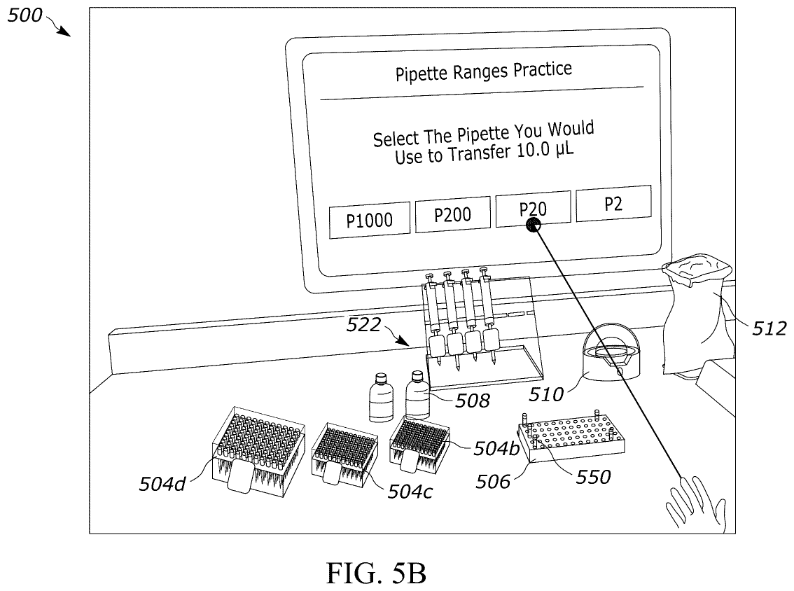

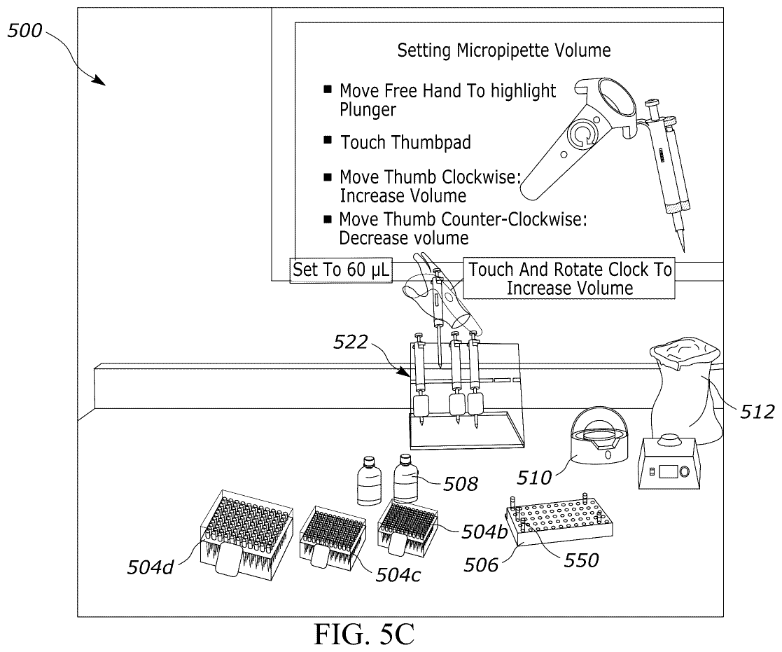

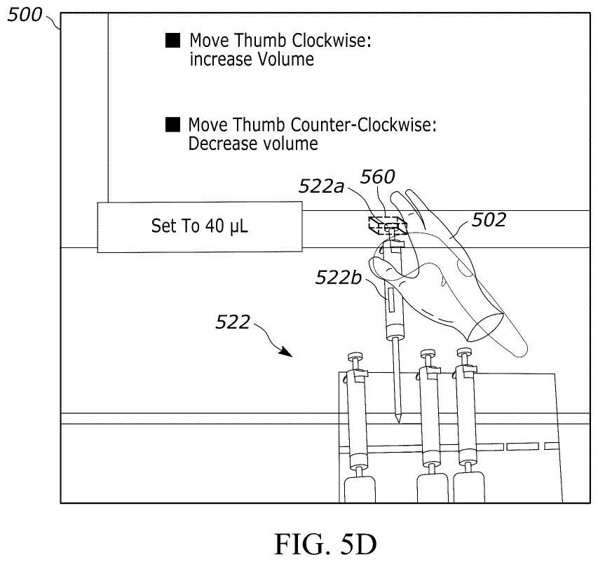

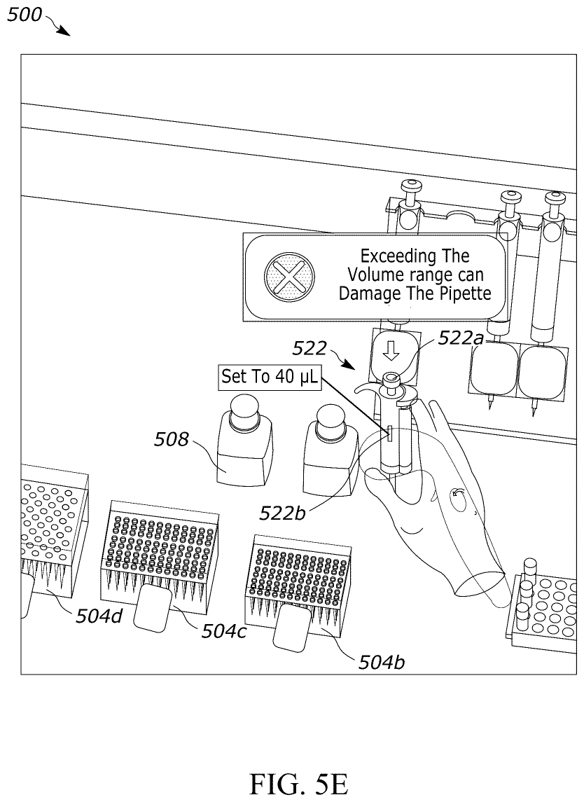

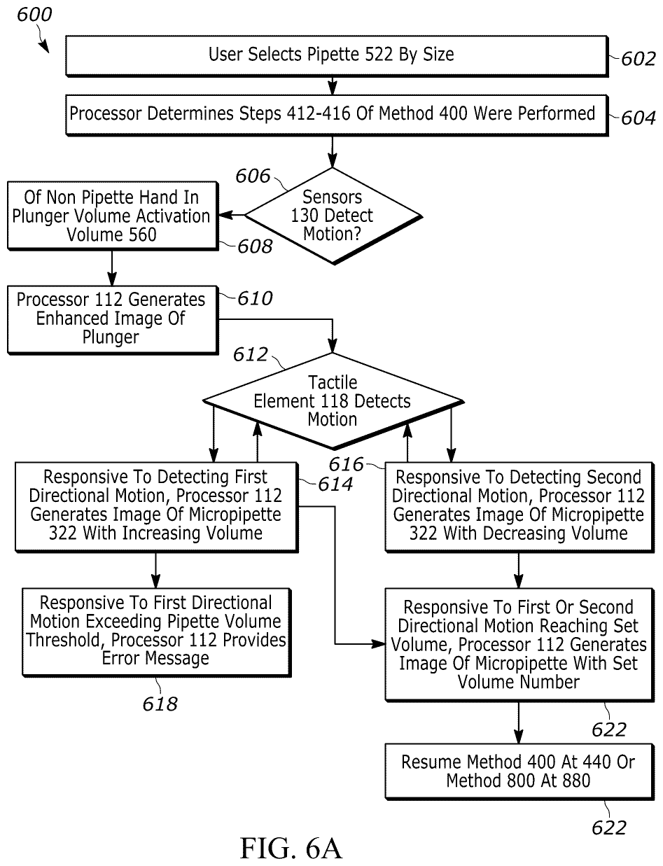

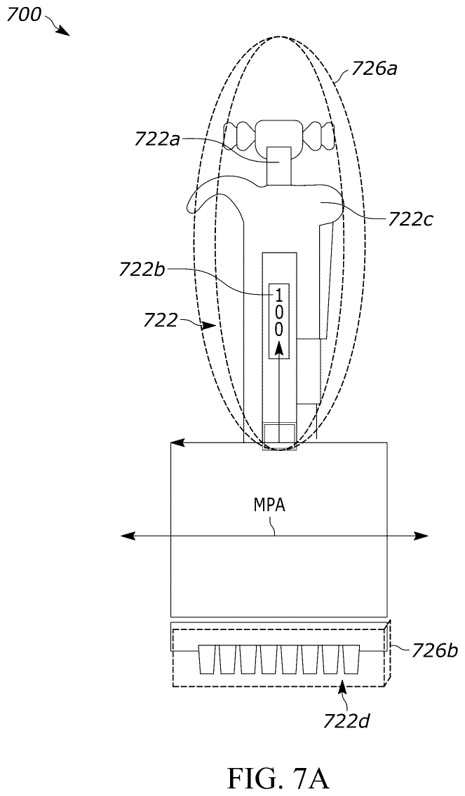

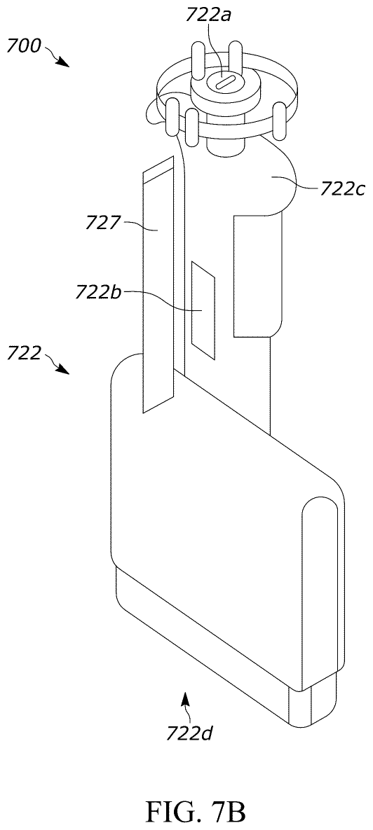

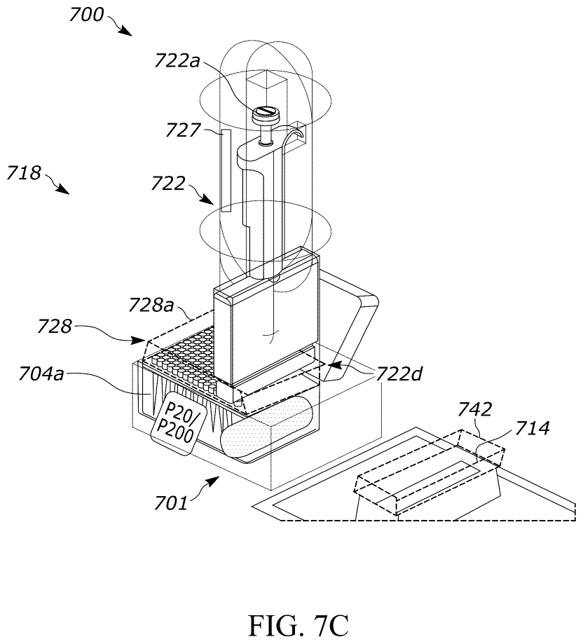

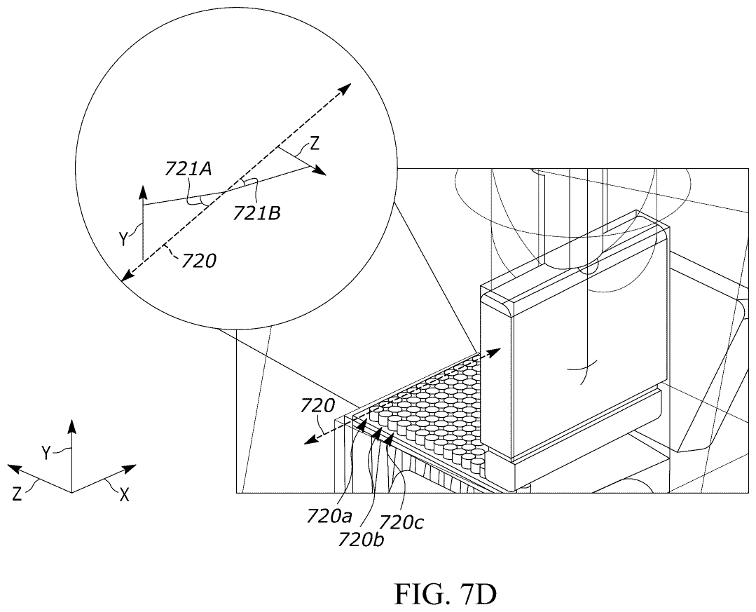

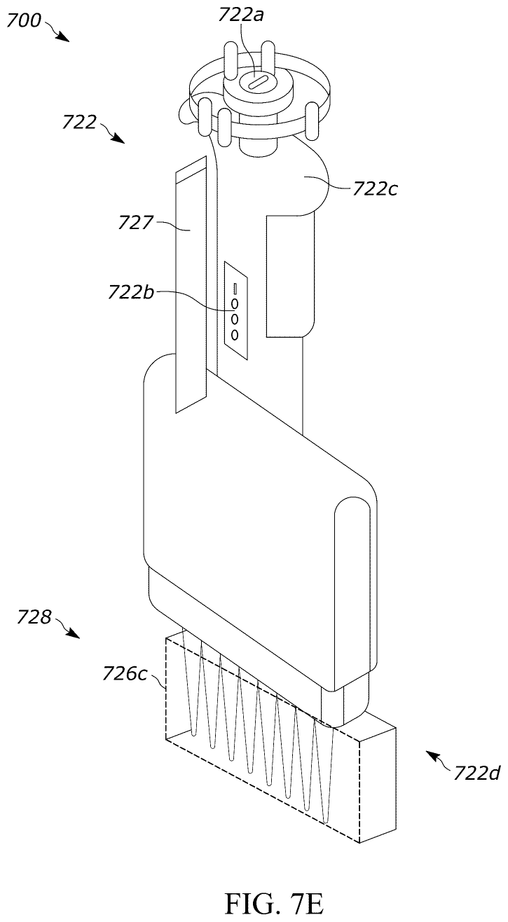

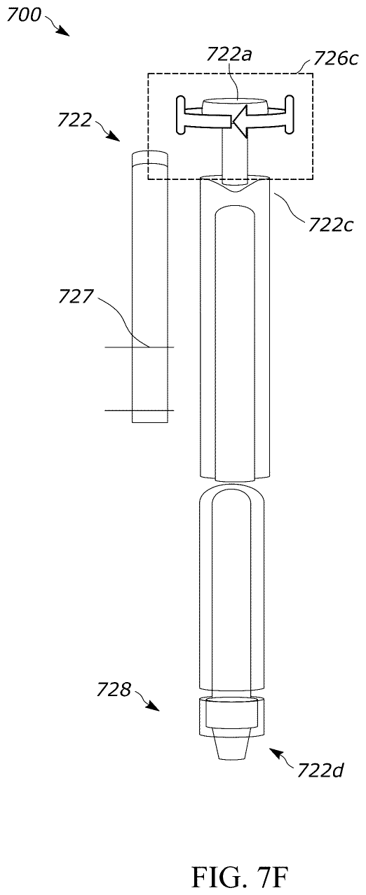

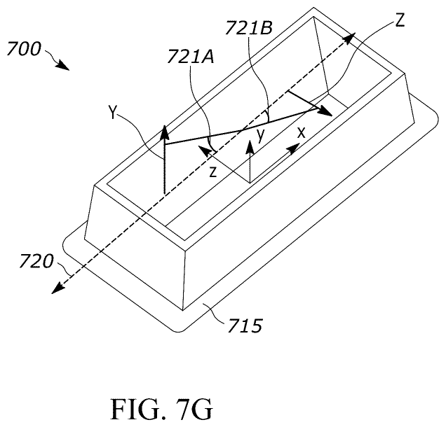

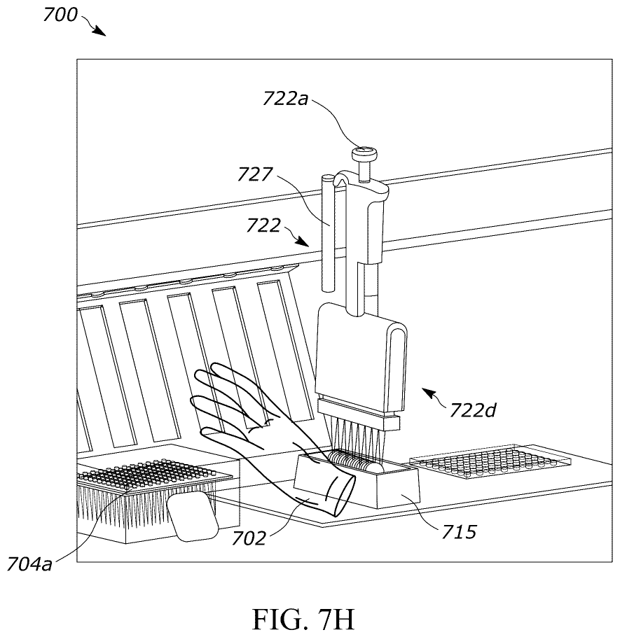

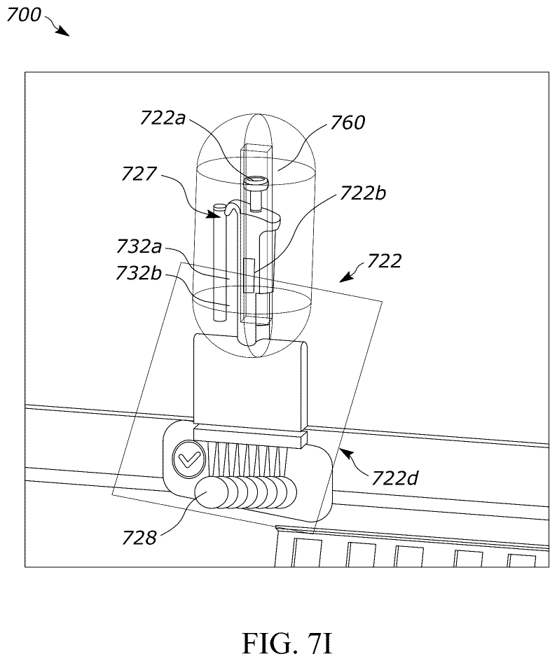

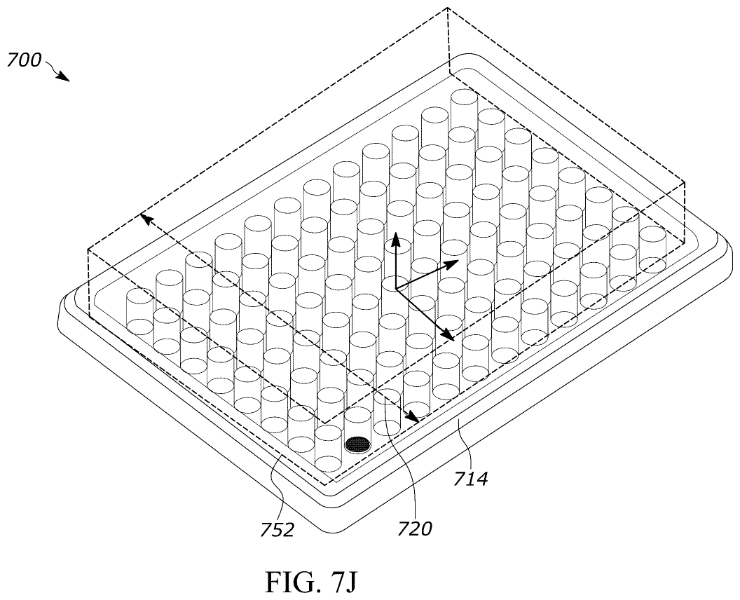

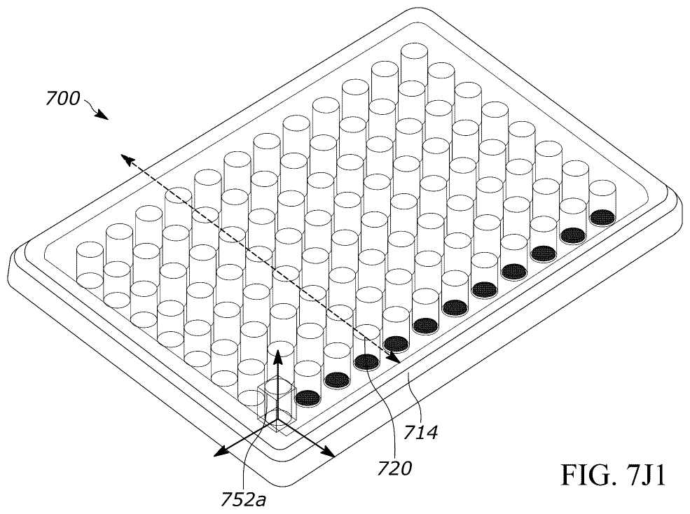

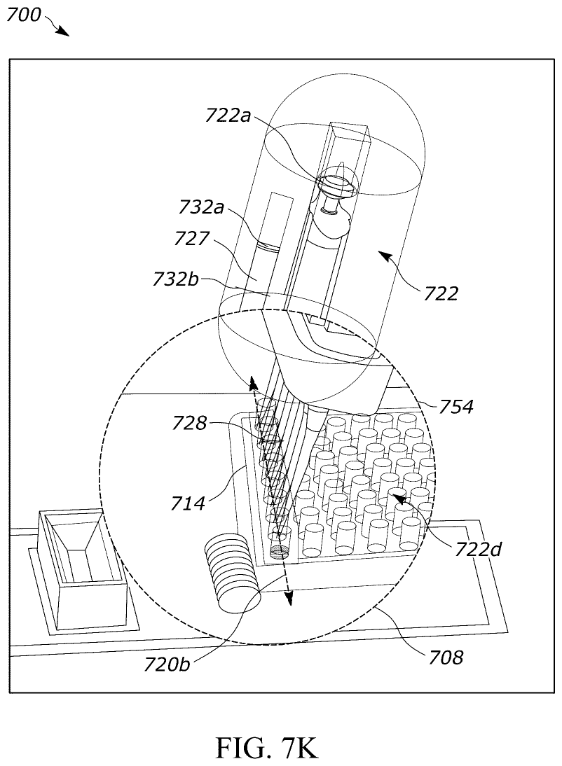

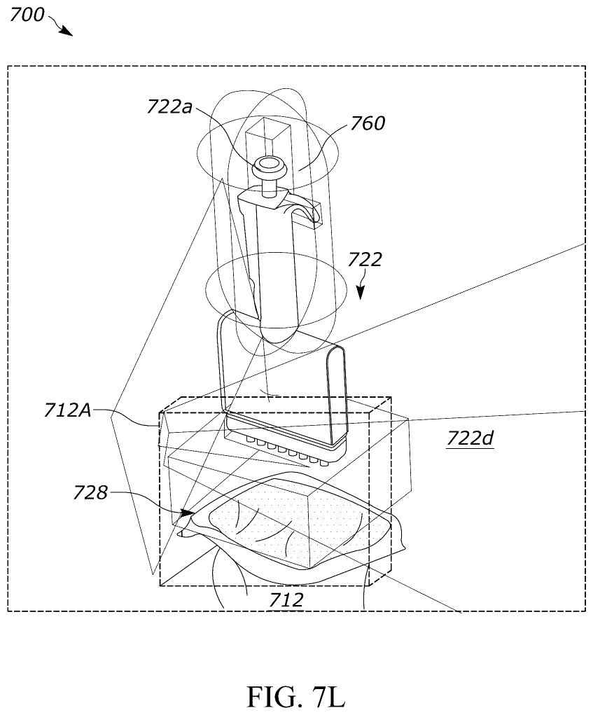

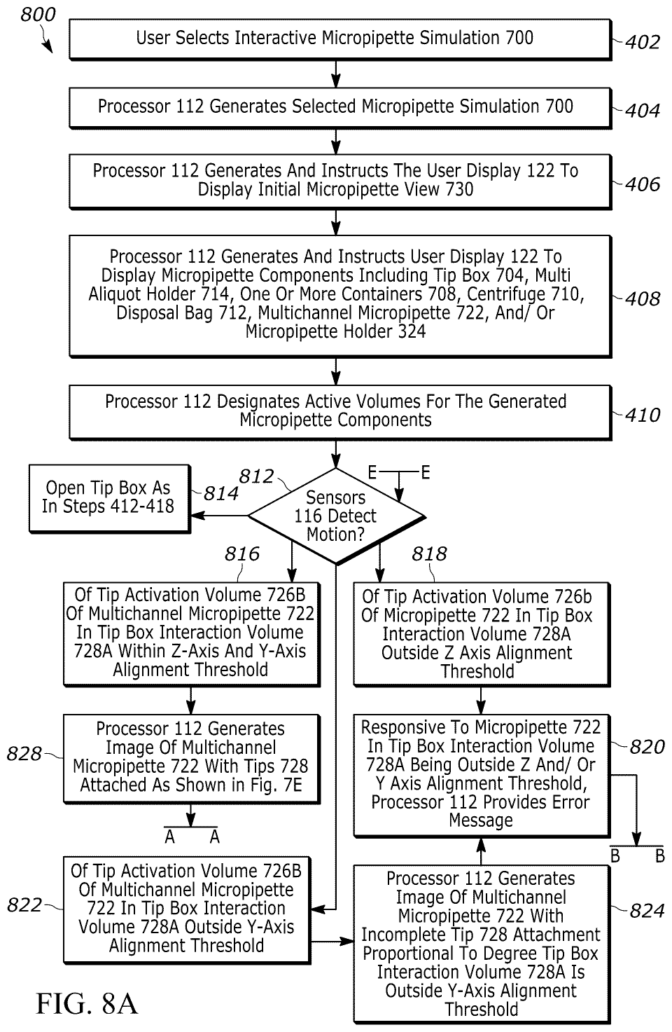

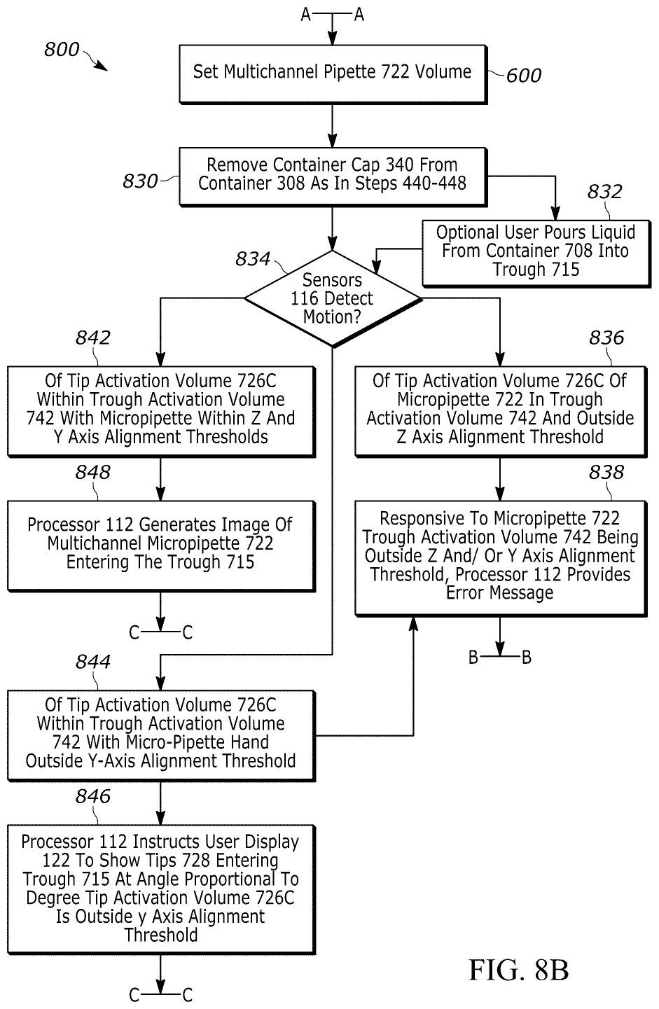

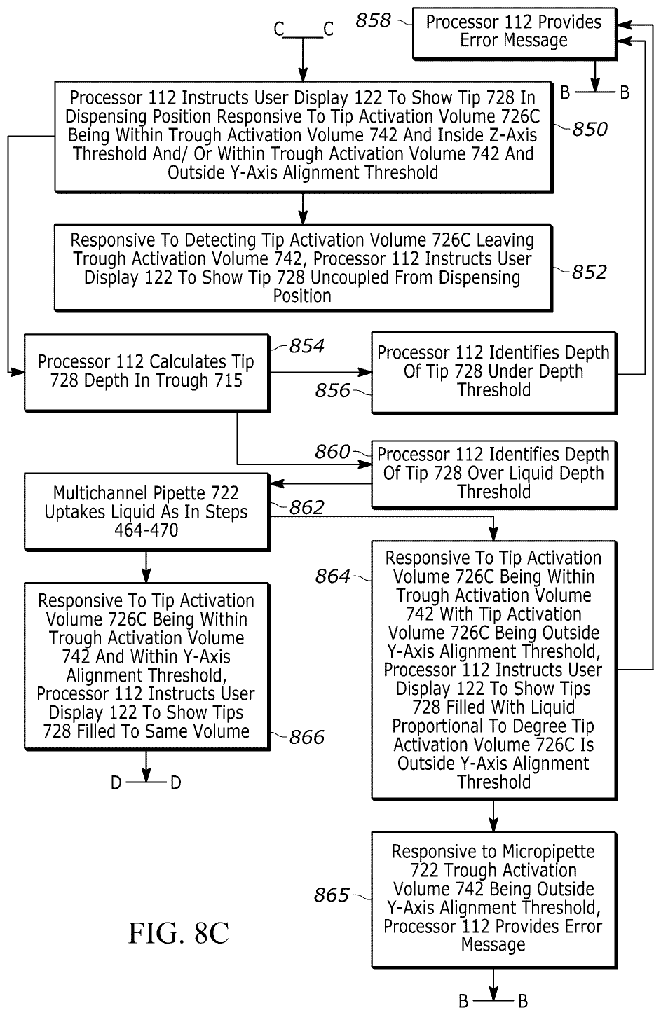

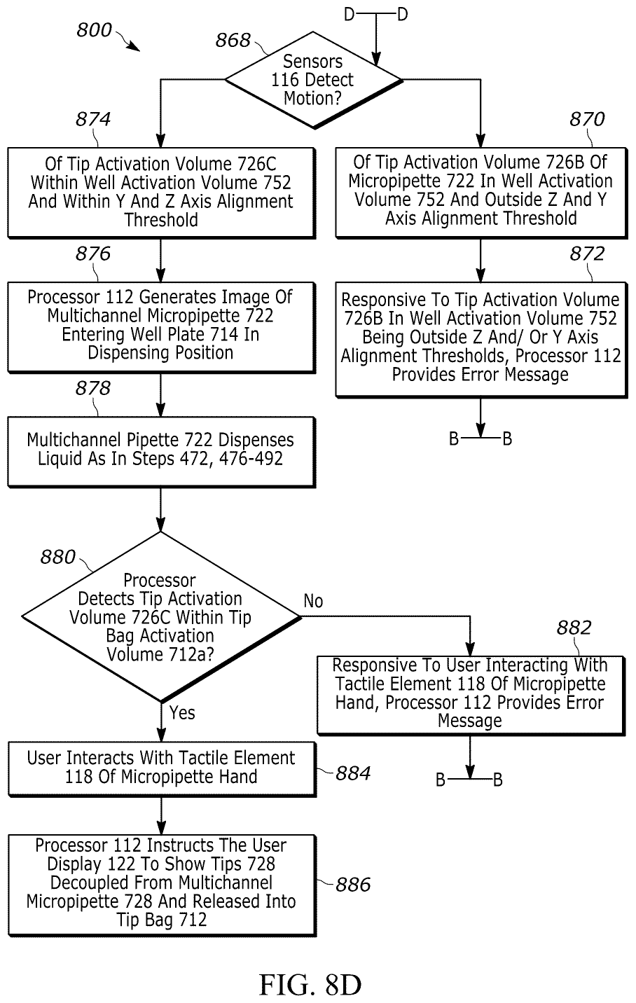

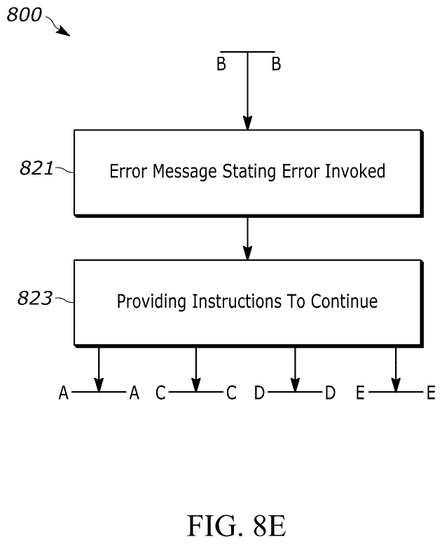

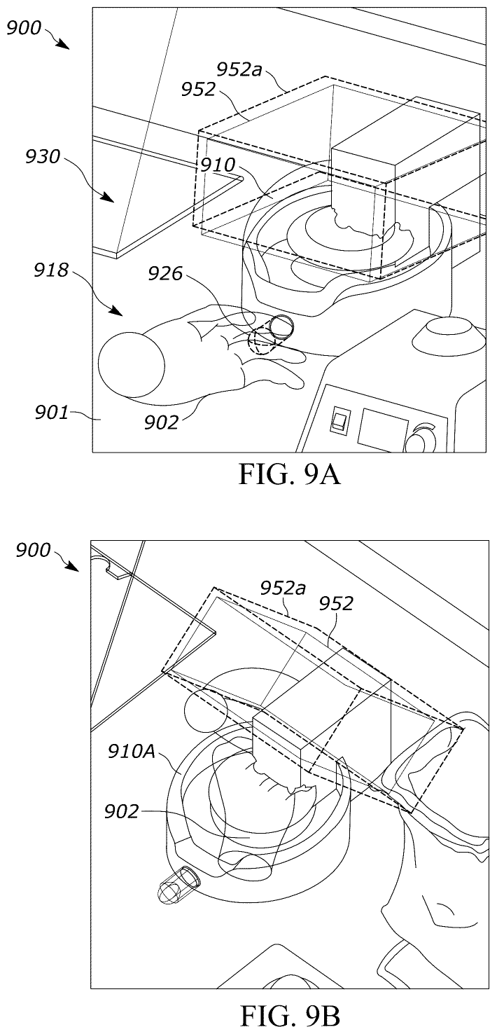

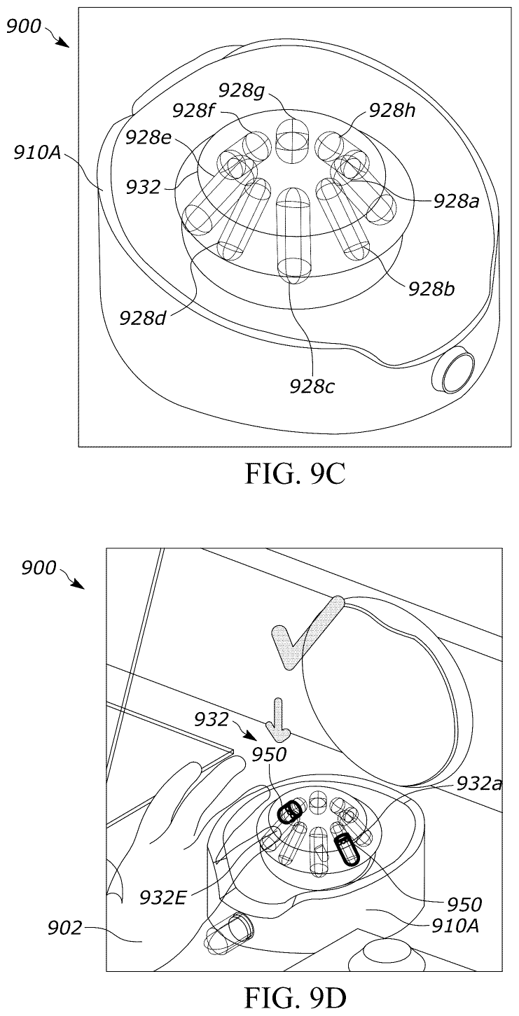

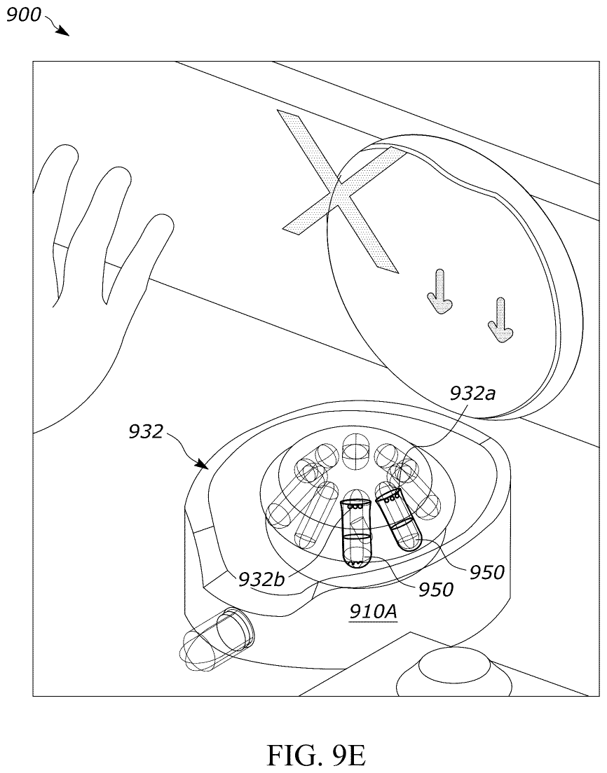

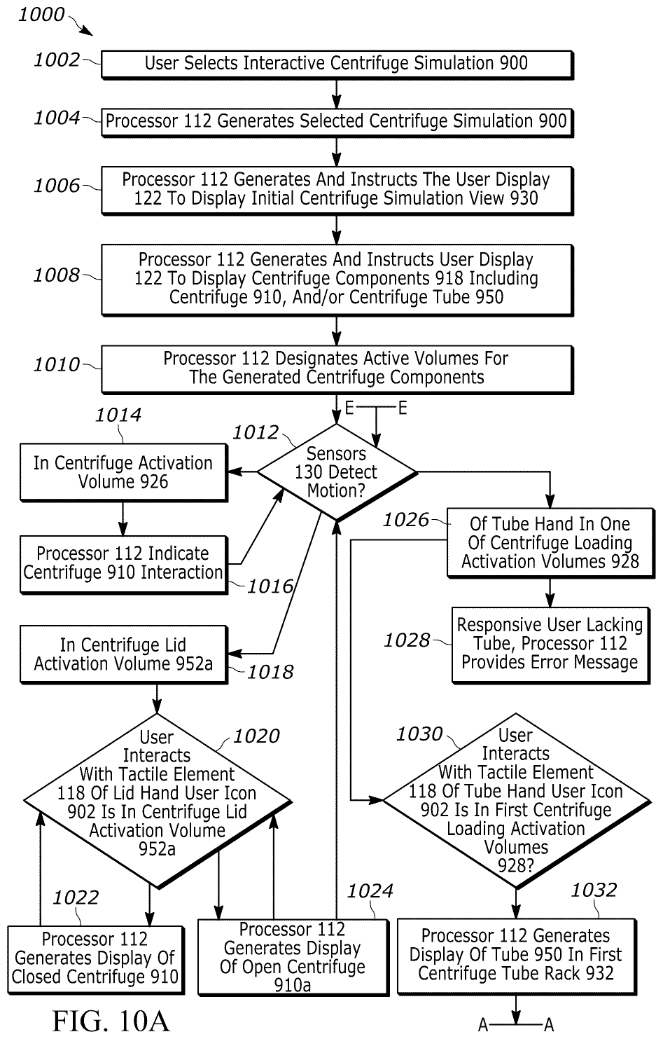

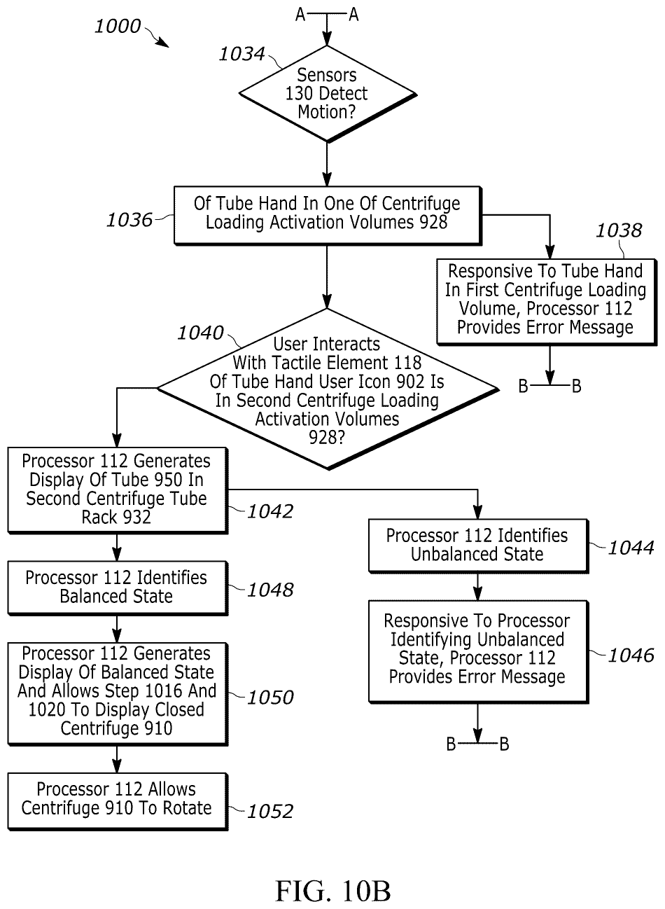

FIG. 3P illustrates a micropipette with a tip interacting with container interaction volume of a container generated by an example virtual reality system, according to one example embodiment of the present disclosure;

FIG. 3Q illustrates a micropipette with a tip interacting with a container generated by an example virtual reality system, according to one example embodiment of the present disclosure;

FIG. 3R illustrates a micropipette with a tip preparing to up take liquid from a container generated by an example virtual reality system, according to one example embodiment of the present disclosure;

FIG. 3R1 illustrates a micropipette in different plunger positions generated by an example virtual reality system, according to one example embodiment of the present disclosure;

FIG. 3R2 illustrates a liquid trigger curve, according to one example embodiment of the present disclosure;

FIG. 3S illustrates a centrifuge tube schematic diagram, according to one example embodiment of the present disclosure;

FIG. 3T illustrates a centrifuge tube, according to one example embodiment of the present disclosure;

FIG. 3U illustrates a micropipette with a tip and a centrifuge tube activation

volume of a centrifuge tube generated by an example virtual reality system, according to one example embodiment of the present disclosure;

FIG. 3V illustrates a micropipette with a tip interacting with centrifuge tube activation volume of a centrifuge tube generated by an example virtual reality system, according to one example embodiment of the present disclosure;

FIG. 3W illustrates a micropipette with a tip having liquid ready to be dispensed into a centrifuge tube generated by an example virtual reality system, according to one example embodiment of the present disclosure;

FIG. 3X illustrates a micropipette with a tip discarding the tip into a waste bag generated by an example virtual reality system, according to one example embodiment of the present disclosure;

FIG. 4A is a schematic diagram of a method of using a selected micropipette simulation generated by an example virtual reality system, according to one example embodiment of the present disclosure;

FIG. 4B is a schematic diagram of a method of using a selected micropipette simulation generated by an example virtual reality system, according to one example embodiment of the present disclosure;

FIG. 4C is a schematic diagram of a method of using a selected micropipette simulation generated by an example virtual reality system, according to one example embodiment of the present disclosure;

FIG. 4D is a schematic diagram of a method of using a selected micropipette simulation generated by an example virtual reality system, according to one example embodiment of the present disclosure;

FIG. 4E is a schematic diagram of a method of using a selected micropipette simulation generated by an example virtual reality system, according to one example embodiment of the present disclosure;

FIG. 5A illustrates a micropipette volume simulation generated by an example virtual reality system, according to one example embodiment of the present disclosure;

FIG. 5B illustrates a micropipette volume simulation, according to one example embodiment of the present disclosure;

FIG. 5C illustrates a micropipette volume simulation, according to one example embodiment of the present disclosure;

FIG. 5D illustrates a micropipette volume simulation with a volume of a pipette being adjusted, according to one example embodiment of the present disclosure;

FIG. 5E illustrates a micropipette volume simulation with an error message being presented, according to one example embodiment of the present disclosure;

FIG. 6A is a schematic diagram of a method of using a selected micropipette volume simulation generated by an example virtual reality system, according to one example embodiment of the present disclosure;

FIG. 7A illustrates a plan view of a multichannel pipette generated by an example virtual reality system, according to one example embodiment of the present disclosure;

FIG. 7B illustrates a perspective view of a multichannel pipette generated by an example virtual reality system, according to one example embodiment of the present disclosure

FIG. 7C illustrates a multichannel micropipette interacting with a tip box generated by an example virtual reality system, according to one example embodiment of the present disclosure;

FIG. 7D illustrates a multichannel micropipette interacting with a tip box generated by an example virtual reality system, according to one example embodiment of the present disclosure;

FIG. 7E illustrates a perspective view of a multichannel pipette with attached tips generated by an example virtual reality system, according to one example embodiment of the present disclosure;

FIG. 7F illustrates a plan view of a multichannel pipette with attached tips generated by an example virtual reality system, according to one example embodiment of the present disclosure

FIG. 7G illustrates a trough generated by an example virtual reality system, according to one example embodiment of the present disclosure;

FIG. 7H illustrates a multichannel micropipette interacting with a trough generated by an example virtual reality system, according to one example embodiment of the present disclosure;

FIG. 7I illustrates a multichannel micropipette in an inspection position generated by an example virtual reality system, according to one example embodiment of the present disclosure;

FIG. 7J illustrates a well plate generated by an example virtual reality system, according to one example embodiment of the present disclosure;

FIG. 7J1 illustrates a well plate generated by an example virtual reality system, according to another example embodiment of the present disclosure;

FIG. 7K illustrates a multichannel micropipette interacting with a well plate generated by an example virtual reality system, according to one example embodiment of the present disclosure;

FIG. 7L illustrates a multichannel micropipette interacting with waste bag generated by an example virtual reality system, according to one example embodiment of the present disclosure;

FIG. 8A is a schematic diagram of a method of using a selected multichannel micropipette simulation generated by an example virtual reality system, according to one example embodiment of the present disclosure;

FIG. 8B is a schematic diagram of a method of using a selected multichannel micropipette simulation generated by an example virtual reality system, according to one example embodiment of the present disclosure;

FIG. 8C is a schematic diagram of a method of using a selected multichannel micropipette simulation generated by an example virtual reality system, according to one example embodiment of the present disclosure;

FIG. 8D is a schematic diagram of a method of using a selected multichannel micropipette simulation generated by an example virtual reality system, according to one example embodiment of the present disclosure; FIG. 8E is a schematic diagram of a method of using a selected multichannel micropipette simulation generated by an example virtual reality system, according to one example embodiment of the present disclosure;

FIG. 9A illustrates a centrifuge simulation generated by an example virtual reality system, according to one example embodiment of the present disclosure;

FIG. 9B illustrates a centrifuge simulation with an open lid, generated by an example virtual reality system, according to one example embodiment of the present disclosure;

FIG. 9C illustrates a centrifuge simulation with an open lid, generated by an example virtual reality system, according to one example embodiment of the present disclosure; FIG. 9D illustrates a centrifuge simulation with an open lid and tubes in a balanced state present therein, generated by an example virtual reality system, according to one example embodiment of the present disclosure;

FIG. 9E illustrates a centrifuge simulation with an open lid and tubes in an unbalanced state present therein, generated by an example virtual reality system, according to one example embodiment of the present disclosure;

FIG. 10A is a schematic diagram of a method of using a selected centrifuge simulation generated by an example virtual reality system, according to one example embodiment of the present disclosure; and

FIG. 10B is a schematic diagram of a method of using a selected centrifuge simulation generated by an example virtual reality system, according to one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure generally relates to an apparatus and methods for virtual reality training, and more particularly to methods and devices utilizing a processor device, visual outputs, sensor devices and special sensors combination for use in facilitating virtual reality simulations including a micropipette simulation, a multi-channel micropipette simulation and/or a centrifuge simulation.

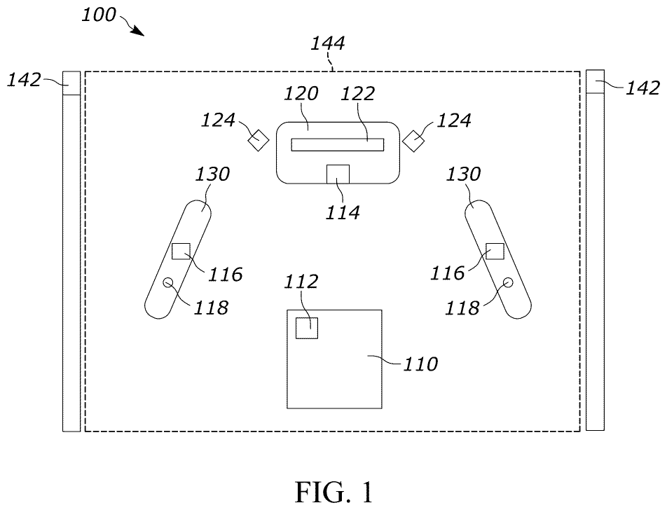

FIG. 1 illustrates a schematic diagram of a virtual reality system 100, in accordance with one of the exemplary embodiments of the disclosure. The virtual reality system 100 includes a processing device 110, a virtual reality headset, “headset 120”, and at least one controller 130, where the processing device 110 is connectable and/or connected to the virtual reality headset 120 and the controller 130.

In one example embodiment, the processing device 110 includes a computing device (e.g. a database server, a file server, an application server, a computer, or the like) with computing capability and/or a processor 112. The processor comprises, a field programmable array (FPGA), a programmable logic device (PLD), an application specific integrated circuit (ASIC), a North Bridge, a South Bridge and/or other similar device or a combination thereof. The processor 112, may for example, comprise central processing unit (CPU), a programmable general purpose or special purpose microprocessor, a digital signal processor (DSP), a graphics processing unit (GPU), and/or other similar device or a combination thereof.

The processing device 110 would generate images, audio, text, etc. that replicate a environments found in the real world, and/or environments generated to be perceived as the real world. The processing device 110 is in two-way communication with the virtual reality headset 120 and the at least one controller 130, wherein the headset and controller provide inputs to the processing device 110 that provides data about the user's actions and motions. The processing device 110 provides instructions to generate visual, audio, and/or text responsive to the inputs received, such that the user navigates and interacts with the virtual world. In one example embodiment, the processing device 110 is integrated with the virtual reality headset 120. In another example embodiment, the processing device 110 is in wired and/or wireless connection with the virtual reality headset 120.

It would be appreciated by having ordinary skill in the art that the processing device 110 would include a data storage device in various forms of non-transitory, volatile, and non-volatile memories which would store buffered or permanent data as well as compiled programming codes used to execute functions of the processing device 110. In another example embodiment, the data storage device can be external to and accessible by the processing device 110, the data storage device may comprise an external hard drive, cloud storage, and/or other external recording devices.

In one example embodiment, the processing device 110 is a remote computer system. The computer system includes desktop, laptop, tablet hand-held personal computing device, IAN, WAN, WWW, and the like, running on any number of known operating systems and are accessible for communication with remote data storage, such as a cloud, host operating computer, via a world-wide-web or Internet. In one example embedment, the controller 130 and VR (virtual reality) headset 120 both contain transceivers for sending and receiving instructions.

In another example embodiment, the processing device 110 comprises a processor, a data storage, computer system memory that includes random-access-memory (“RAM”), read-only-memory (“ROM”) and/or an input/output interface. The processing device 110 executes instructions by non-transitory computer readable medium either internal or external through the processor that communicates to the processor via input interface and/or electrical communications, such as from a secondary device (e.g., smart phone, tablet, or other device) the controller 130 and/or the headset 120. In yet another example embodiment, the processing device 110 communicates with the Internet, a network such as a LAN, WAN, and/or a cloud, input/output devices such as flash drives, remote devices such as a smart phone or tablet, and displays.

The virtual reality headset 120 would be a head-mounted display or goggles 122 with a build-in head-tracking system. An example headset 120 made by Facebook part titled Quest, which is incorporated by reference in its entirety for all purposes. The virtual reality headset 120 includes the integrated display 122, a headset motion sensor 114, a communication interface, and/or a user speakers 124, and a built-in processor for executing or reading instructions from memory, or an input for providing instructions to an output.

The display 122 may comprise one of a liquid crystal display (LCD), a light-emitting diode (LED) display, or the like. The motion sensor 114 may comprise a combination of an accelerometer (e.g. G-sensor), a gyroscope (e.g. gyro-sensor), and/or a sensor that detects the linear and/or rotational movement (e.g. rotational angular velocity or rotational angle) of the headset 120. In another example embodiment, the motion sensor includes one or more locators 142 that generate a motion sensing grid 144, wherein motion of the controller 130 and/or the headset 120 is monitored, and identified by the one or more sensors. The controller 130 and/or the headset 120 include one or more sensed volumes, such that the motion sensing grid senses linear and/or rotational movement. The locator 142 includes, for example, a laser or an infrared transmitter and receiver. The locator 142 maps where the virtual reality headset 120 and the controller 130 are in three dimensional space. Further, the locators 142 via instruction from the processor 112 define boundaries of the virtual space to prevent the user from bumping into walls or collisions with physical objects while in the virtual world.

In one example embodiment, the locator 142 comprises base stations including, for example, a spinning laser sheet. Sensors 114, 116 on the headset 120 and controllers 130 detect transmit to the processor 112 when (e.g., a specific time) the laser sheet passes various points on the headset 120 and/or the controller 130. The processor 112, utilizing a time the various points were detected, triangulates position and orientation of the controller 130 and/or headset 120 from the times. In another example embodiment, the sensor 114 of the headset 120 (e.g., an Oculus Rift S of an Oculus Quest headset) comprises onboard cameras that transmit data to the processor 112, or comprising processing power themselves to calculate position and orientation via photogrammetry. In yet another example embodiment, the locator 142 comprises one or more cameras that detect lights that are projected from the headset 120 and controllers.

In the illustrated example embodiment, the headset 120 outputs headset motion data to the processing device 110 (e.g., via the locator 142, and/or motion sensors) and the processor 112 of the processing device instruct the headset to display images on the user display 122 that correlate the headset motion data (e.g., the user turns their head left, and the display alters to show a volume leftward of the user's original gaze).

In the illustrated example embodiment of FIG. 1, the controller 130 comprises a handheld controller. In one example embodiment, the controller 130 is equipped with a handheld motion sensor 116, a tactile element 118, for example, a mouse, a joystick, a trackball, a touch pad, and/or buttons that permits the user to interact with environment, objects, or avatars in the virtual world (the virtual world is what is being displayed in the headset 120 based upon movement of the headset, the controller, and based upon instructions processed by processor 112, and or controller 130, these instructions are received by their respective inputs and processed by respective processor to provide non-transitory instructions to the respective devices 120, 130). In one example embodiment, such instructions are non-transitory, such as computer readable media, that can be transmitted to the devices of the system 100 to be processed on the respective processor of the respective devices 120, 130. The controller 130 communicates with the processing device 110, the locators 142, and/or the headset 120 via any wireless standard and/or is in wired communication with the processing device 110. It would be appreciated by one having ordinary skill in the art that handheld motion sensor includes sensors 116 located on the controller 130, and/or sensible elements that are sensed by other devices, such as the locator 142.

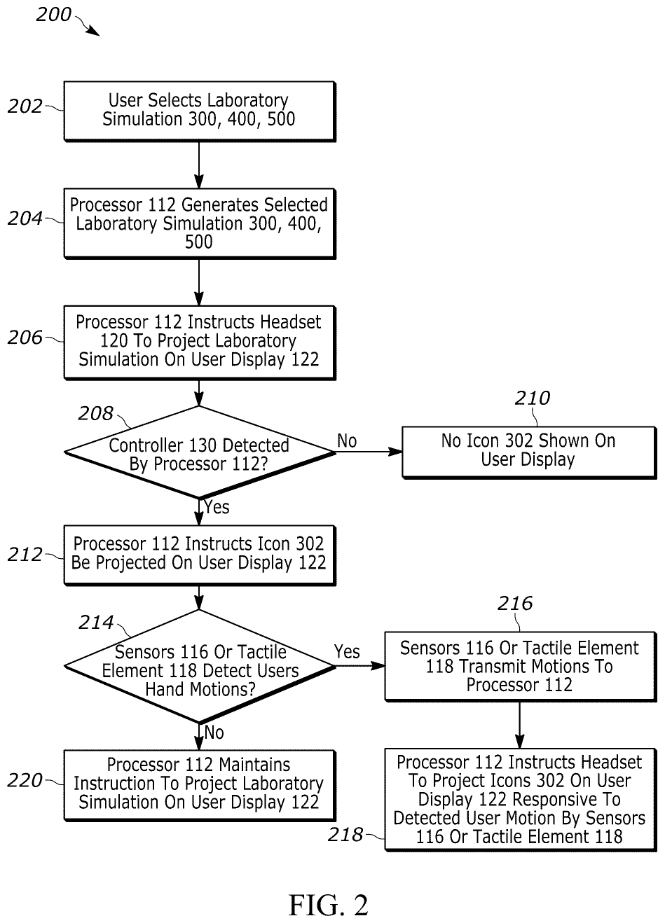

As illustrated in FIG. 2, a method 200 of use of the virtual reality system 100 is illustrated. At 202, a user, utilizing the virtual reality system 100 selects a laboratory simulation 300, 500, 700. In this example embodiment, the user has access to a plurality of laboratory simulations which will be discussed in greater detail below. The user may select the laboratory simulation 300, 500, 700 utilizing the controller 130 and/or the tactile element 118 of the controller, the processing unit 110 (e.g., a mouse, keyboard, or the like in communication with the processing unit), and/or through eye and/or head motion sensed by the headset 120. At 204, the processor 112 generates the selected laboratory simulation 300, 500, 700. In this example embodiment, the processor 112 identifies a simulation stored on the processor, and/or stored at a remote location, and configures the laboratory simulation to be projected on the attached headset 120.

At 206, the processor 112 sends instructions to the headset 120 to project the selected laboratory simulation 300, 500, 700, 900 on the user display 122, to generate audio to be emitted from the user speakers 124, and/or rumbling, motion to be actualized at the headset 120 and/or the controller 130. In this example embodiment, the user holds, or otherwise controls the motion of the controller 130. At 208, a presence of the controller 130 in a working volume (e.g., the motion sensing grid 144) is searched for. At 210, responsive to no controller 130 being detected, the processor 112 instructs that no icon 302 be shown on the user display 122 (see FIG. 3A). At 212, responsive to the controller 130 being detected, the processor 112 instructs that the icon 302 be shown on the user display 122 (see, for example, FIG. 3B). In one example embodiment, the icon 302 comprises a hand, and/or hands, which mimic the user's hands in the virtual space or virtual world. At 214, the sensor 116 of the controller is activated to detect the user's hand motion. The sensor 116 may be detected by the locators 142. The user's hand motions, including lateral, longitudinal, rotational, axial, etc. is detected by the sensor 116. The sensor 114 of the headset 120 remains active while the user is in the virtual space.

At 216, responsive to the sensors 114, 116 detecting the motion of the user, the sensors 114, 116, the locators 142, and/or both transmit the motion to the processor 112. At 218, the processor 112 instructs the headset 120 to project the icons 302 as moving in the same manner as detected by the sensors 116, the tactile element 118 and/or the locators 142 and/or alter the user's view on the user display 122 based upon the motion detected from the sensor 114. In this example embodiment, the icons 302 will move up or down, side to side, rotationally, etc. relative to the user if the controller 130 is detected as moving up and down, side to side, in and out, and/or rotationally. In another example embodiment, the icon 302 will move rotationally, up, down, or side to side, responsive to the user interacting with the tactile element 118. For example, if the user has rotational contact with the tactile element 118, the element the user is interacting with will act in a prescribed manner (discussed in detail below). At 220, responsive to the sensor 116 or the tactile element 118 not detecting the motion of the user, the sensors 114, 116, the tactile element 118, the locators 142, and/or all of them transmit that there is no motion to the processor 112. The processor 112 maintains instructions to project the selected laboratory simulation 300, 500, 700 on the user display 122. The selected laboratory simulation 300, 500, 700, 900 includes the icons 302. 502, 702, 902 when the controller 130 is detected, as at 212, or does not include the icons 302 when the controller is not detected, as at 210.

### Micropipette Simulation 300

As illustrated in FIG. 4A, a method 400 of use of the virtual reality system 100 with the interactive micropipette simulation 300 is illustrated. At 402, the processor 112 receives a signal indicating the user has selected the interactive micropipette simulation 300 (see FIG. 3A). At 404, the processor 112 generates the micropipette simulation 300, including generating an image of a micropipette 322 and instructs the user display 122 to display the micropipette simulation.

At 406, the processor 112 generates and instructs the user display to display an initial micropipette view 330. A micropipette view 330 comprises the micropipette 322 that illustrates a micropipette as presented in the real world. The initial micropipette view 330 comprises the view prior to user input, and subsequent altered micropipette views comprise the view including the user input. In another embodiment, the sensor 116 sends a signal to the processor 112 that the controller 130 is within an activation volume. The activation volume comprises a Cartesian coordinate system defining an activation distance (e.g. between 6 inches to 12 inches) of the virtual reality micropipette 322. The activation distance defines a three-dimensional volume that extends along x, y, and z axes. At 408, the processer 112 generates and instructs the user display 122 to display micropipette components 318. The micropipette components 318 include the tip box 304, a centrifuge tube holder 306, one or more containers 308, a centrifuge 310, a waste bag 312, the micropipette 322, a micropipette holder 320, and/or other sample stimulation machines 316 (see, for example, FIGS. 3A-3B). Steps 404-410 may be performed in any order, and/or may be performed simultaneously. In the example embodiment, the micropipette components 318 are supported by a lab bench 301.

At 410, the processor 112 designates a micropipette activation volume 326, a micropipette grip activation volume 326a, a micropipette tip activation volume 326b, a micropipette tip dispensing activation volume 326c, a tip interaction volume 328a, a container cap interaction volume 342, a container interaction volume 342a, a centrifuge tube activation volume 352, a waste bag activation volume 312a, a tip box activation volume 305 and/or other sample stimulation machine volumes (see FIGS. 3C, 3E, 3G, 3O-3P, 3U-V, 3X) in Cartesian coordinate systems corresponding to the tip box 304, the centrifuge tubes 350, the one or more containers 308, a centrifuge 310, the waste bag 312, the micropipette 322, and/or the other sample stimulation machines. In this example embodiment, the activation volumes 326, 326a, 326b, 326c, 328a, 342, 342a, 352, 312a, 305 comprise three dimensional spatial coordinate volumes radiating out along x, y, and z axes (hereinafter “volume” unless otherwise defined) from a central location (coordinates 0,0,0) wherein the respective micropipette component 318 is located, or a center point of the respective micropipette component 318. In this embodiment, the activation volumes 326, 326a, 326b, 326c, 328a, 342, 342a, 352, 312a, 305 extend between 1 inch to about 7 inches along the x axis, between 1 inch to about 7 inches along the y axis, and/or between 1 inch to about 7 inches along the z axis, wherein the volume defined within comprises the respective activation volumes. In another embodiment, the activation volumes 326, 326a, 326b, 326c, 328a, 342, 342a, 352, 312a, 305 extend between 1 centimeter to about 3 centimeters along the x axis, between 1 centimeter to about 3 centimeters along the y axis, and/or between 1 centimeter to about 3 centimeters along the z axis, wherein the volume defined within comprises the respective activation volumes. Distances in vertical space are based upon perceived distance by the user. At 412, the sensor 116 detects motion. In another example embodiment, the activation volume is defined as an invisible collision volume or an absolute distance from that micropipette components 318. At 414, the sensor 116 detects motion in the micropipette grip activation volume 326a. In this example embodiment, the micropipette grip activation volume 326a engulfs the grip portion of the micropipette 322 and extends between 0.5 inches to 2 inches around the grip portion. At 416, responsive to the sensor 116 detecting motion in the micropipette grip activation volume 326a, the processor 112 generates image of the user holding the micropipette 322 and links the micropipette to user movement of the sensor 116. (see FIG. 3D). The sensor 116 linking user movement to the micropipette movement is designated the micropipette hand, the sensor that is not linked to micropipette movement is designated the non-micropipette hand.

At 418, the sensor 116 detects motion in the tip box activation volume 305. (see FIG. 3E). At 420, responsive to the sensor 116 detecting motion of the non-micropipette hand in the tip box activation volume 305, the processor 112 generates a display of an open tip box 304a (see FIGS. 3F). In one example embodiment, responsive to the sensor 116 detecting motion of the micropipette hand in the tip box activation volume 305, the processor 112 generates one of an error message or a display of the open tip box 304a. Stated another way, as the sensor 116 detects motion in the tip box activation volume 305, the processor 12 registers that the sensor is within tip box activation volume 305 (e.g., near a top of the tip box 304), indicating to the processor that the tip box is being targeted to be interacted with. Responsive to the sensor 116 being actuated while in the tip box activation volume 305, the processor 112 identifies a current state of the tip box 304 (open or closed) and changes tip box's 304 state to the opposing state, either generating movement of the tip box opening or closing, whichever is opposite of the tip box's initial state.

At 422, the sensor 116 detects motion in the tip activation volume 326b of the micropipette 322 in the tip box interaction volume 328a (see FIG. 3G). In one example embodiment, each tip 328 within the tip box 304 has its own, fitted, activation volume. At 424, responsive to the sensor 116 detecting motion in the tip activation volume 326b and responsive to steps 416 and 420 being complete, the processor 112 determines if a design size of the micropipette 322 matches to a tip size of the tip box 304. In this example embodiment, there are four different micropipettes for different volume ranges (e.g., P1000, P200, P20, and P2). In this example embodiment, the tip box 304 is used to hold one or more micropipette tips 328. The micropipette tips 328 are attachable and ejectable from the micropipette 322. In the example embodiment, the processor 112 generates a plurality of different size tips, and each micropipette 322 is generated by the processor to be compatible with a particular tip size. In one example embodiment, the plurality of different size tips are sorted into specific tip boxes 304 based upon size. In one example embodiment, the specific tip boxes 304 are differentiated by a visual indicator, such as text, color, or texture. In the illustrated example embodiment of FIG. 3H, the specific tip boxes 304 are different colors modeling the color coordination of real-world tips and their boxes.

At 428, responsive to the sensor 116 detecting motion in the tip box interaction volume 328a and responsive to steps 416 and 420 being incomplete and/or the tip size of the tips 328 being a mismatch, the processor 112 provides an error message at B-B. (see FIG. 3H). Continued from section line B-B in FIG. 4A, illustrated in FIG. 4E as continuing from section line B-B at 421 an error message stating the specific error is generated by the processor 112 and presented to the user. At 423, the processor 112 provides instruction on how to continue, including proceeding to any of the recited method steps of the method 400. In this example embodiment, responsive to the sensor 116 assigned to the micropipette hand detecting interaction with the tip box 304 that is not consistent with correct techniques in the real world, the processor will trigger an error popup as described at steps 421 and 423. For example, responsive to the sensor 116 assigned to the micropipette hand detecting interaction with the tip box 304 having a wrong size tip, an “Apply the proper-sized tip” popup will appear. The processor 112 will identify a size assigned to the tip 328 and access a list of valid sizes that are defined within the micropipette 322 that is attempting to apply the tip, and if they do not overlap will identify an error.

Continuing method 400 in FIG. 4A, at 426, responsive to the sensor 116 assigned to the micropipette hand detecting motion in the tip box interaction volume 328a and responsive to steps 416 and 420 being complete and the tip size of the tips 328 being a match, the processor 112 generates an image of the micropipette 322 with the tip 328 attached (see FIGS. 3I, 3K-3L). In another example embodiment, responsive to the sensor 116 assigned to the micropipette hand detecting that the micropipette tip activation volume 326b is interacting with the tip box interaction volume 328a and responsive to steps 416 and 420 being complete and the tip size of the tips 328 being a match the processor 112 generates image of the micropipette 322 with tip 328 attached. In yet another example embodiment, responsive to the sensor 116 assigned to the micropipette hand detecting that the micropipette tip activation volume 326b is interacting with a specific tip having the tip box interaction volume 328a and responsive to steps 416 and 420 being complete and the tip size of the tips 328 being a match, the processor 112 generates an image of the micropipette 322 with a tip 328 attached.

The micropipette tips 328 are attachable to a barrel 322d of the micropipette 328. (see FIG. 3k). The processor 112 detects that the sensor 116 assigned to the micropipette hand is in range of the open tip box 304a because it has entered into the tip box interaction volume 328a (e.g., a cube trigger volume of the open tip box). The processor 112 then checks if the micropipette 322 currently has a tip 328 or not. If the micropipette 322 is tipless, the processor 112 applies the tip 328 to the micropipette 322 and removes it from the open tip box 304a. The processor 112 monitors the approach of the micropipette 322 to assure the sensor 116 assigned to the micropipette hand travels past an attachment threshold of tip box interaction volume 328a (e.g., applies firm pressure), to trigger a proper seating of the tip 328. Responsive to the processor 112 detecting that the sensor 116 assigned to the micropipette hand failed to pass the attachment threshold and/or entered at an improper angle (e.g., the improper angle between 90° to 270° relative to a vertical axis VA (see FIG. 3G)), the processor 112 will detect these poor techniques and will trigger an error message popup as outlined at 421-423 in FIG. 4E. In one example embodiment, the processor 112 generates an image of the tip 328 to be seated improperly, crookedly, or falling off the micropipette 328, prior to initiating the error message. By monitoring the angle and speed of approach/application of the barrel 322d, the processor 112 checks angle and speed values against preconfigured thresholds (e.g., the improper angle and/or the attachment threshold) that are tuned by subject matter experts to allow tolerances of motion that would generally be accepted as correct behavior in the application of physical tips to a physical micropipette in the physical world.

At 430 the sensor 116 detects motion. At 432, the sensor 116 detects motion in the tip box activation volume 305 with the non-micropipette hand. At 434, responsive to the sensor 116 detecting motion in the tip box activation volume 305 and responsive to steps 416 and 420 being complete, the processor 112 generates an image of the tip box 304 in the closed position. (see FIG. 3J)

At 436, the sensor 116 detects motion in the tip box activation volume 305 with the micropipette hand. At 438, responsive to the sensor 116 detecting motion in the tip box activation volume 305, the processor 112 provides an error message at B-B. Continued from section line B-B in FIG. 4A, illustrated in FIG. 4E as continuing from section line B-B, steps 421 and 423 are completed.

Continued from section line A-A in FIG. 4A, illustrated in FIG. 4B as continuing from section line A-A, at step 600, described in detail in method 600, and FIGS. 5A-5E, a volume of the micropipette 322 is set. At 440, the sensor 116 detects motion in the container cap interaction volume 242 with the non-micropipette hand. (See FIGS. 3N-3O). At 444, responsive to the processor 112 receiving a signal from the sensor 116 that the micropipette hand is in the container cap interaction volume 242, the processor instructs the user display 122 to display an error message. In another example embodiment, responsive to the processor 112 receiving a signal from the sensor 116 that the micropipette hand is in the container cap interaction volume 242, the processor instructs the user display 122 no action. Continued from section line B-B in FIG. 4B, illustrated in FIG. 4E as continuing from section line B-B, steps 421 and 423 are completed. At 442, responsive to the processor 112 receiving a signal from the sensor 116 that the non-micropipette hand is in the container cap interaction volume 242, the processor instructs the user display 122 to display a cap 340 being removed from the container 308. (see FIG. 3N). At 448, the processor 112 receives a signal from the sensor 116 that the non-micropipette hand is in the container activation volume 242. At 450, responsive to the processor 112 receiving a signal from the sensor 116 that the non-micropipette hand is in the container activation volume 342, the processor instructs the user display 122 to display an error message. Continued from section line B-B in FIG. 4B, illustrated in FIG. 4E as continuing from section line B-B, steps 421 and 423 are completed. In another example embodiment, the processor 112 allows the non-micropipette hand to enter the container activation volume 342 without generating an error message.

At 446, the processor 112 receives a signal from the sensor 116 that the tip activation volume 326C of the micropipette 322 is in the container activation volume 242. At 452, responsive to the processor 112 receiving a signal from the sensor 116 that the tip activation volume 326C of the micropipette 322 is in the container activation volume 242, the processor instructs the user display 122 to display the tip 328 entering the container 308. (see FIG. 3P). At 452, responsive to the processor 112 receiving a signal from the sensor 116 that the tip activation volume 326C of the micropipette 322 is in the container activation volume 242, the processor instructs the user display 122 to display to show the tip 328 in a dispensing position. (see FIGS. 3P-3R). In one example embodiment, the dispensing position is wherein the micropipette 322 extends along a vertical axis (e.g., the micropipette is straight up and down). In another example embodiment, the dispensing position is wherein the micropipette 322 extends along a dispensing axis that is transverse to the vertical axis by between 1° to about 10°. In one example embodiment, the dispensing position includes a magnetic attraction to the container 308 or container with which the tip 328 is interacting. At 456, responsive to the sensor 116 detecting the tip activation volume 326c of the tip 328 leaving the container activation volume 242, the processor 112 instructs the user display 122 to show the tip 328 uncoupled from dispensing position and removed from an interior surface of the container 308. For example, absent the completion of step 456, the tip 328 and the micropipette 322 will return to a designated contact spot within the container 308 and/or other container after the sensor 116 detects movement.

Step 456 is completed any time the sensor 116 detects the tip activation volume 326c of the tip 328 leaving the container activation volume 342. The user will still be assigned the micropipette hand and the non-pipette hand, and the cap 340 of the container 308 will remain removed absent action by the user. In one example embodiment, the non-pipette hand that removed the container cap 340 is displays the container cap in virtual space. In another example embodiment, the container cap 340 is placed on a sterile surface/wipe before the non-pipette hand once again picks up the container cap and replaces it on the container 308. In yet another example embodiment, the container cap 340 once removed is no longer presented. In this example embodiment, while the micropipette hand is holding the micropipette 322, typically if the user were to interact with the tactile element 118 on the controller 130, the processor 112 would instruct the display to display actuation of the micropipette 322 plunger. However, if the processor 112 receives a signal that the micropipette-hand has moved into an activation volume 328a, 342, 352, 312a, 305 of a designated interactable, the processor 112 instructs in this context to will allow the user to engage the tactile element 118 to interact with the designated interactable instead of actuating the plunger 322a. In one example embodiment, if the micropipette 322 in the right controller 130 (e.g., the micropipette hand) and a container 308 of liquid with the left controller 130 (e.g., their non-pipette hand). In some example embodiment, the container 308 is empty. When the micropipette hand is in the container cap interaction volume 342 of the cap 340 of the container 308, if the user engages the controller 130 tactile element 118, the processor 112 will respond by instructing the user display 122 to show the container as open without the container cap (e.g., removing the cap and placing it in the user's micropipette hand and/or in virtual space).

At 458, if step 456 is omitted, the processor 112 calculates a tip depth in the container 308. At 460, the processor 112 identifies a depth of tip 328 as over depth threshold and/or detects a micropipette tip entry activation volume 326d interacting with the container interaction volume 342a. (see FIG. 3P). The micropipette tip entry activation volume 326d is a volume assigned to the micropipette 322 by the processor 112 that corresponds to a point on the micropipette that should not interact with the liquid and/or the container 308 in the real world. In one example embodiment, the micropipette tip entry activation volume 326d is located where the tip 328 and the barrel 322d interact. In one example embodiment, the tip depth is over the depth threshold wherein the tip will interact with a bottom of the container 308 in a forceful or damaging way in the real world. Concurrently or in parallel with step 460, at 462, the processor 112 identifies a depth of the tip 328 relative to the liquid displayed in the container 308. (see FIG. 3P). Wherein, if the tip 328 is under a liquid depth threshold, the tip has not broken the plane of the liquid and will not be able to uptake liquid. In another example embodiment, if the tip 328 is under the liquid depth threshold, the tip has broken the plain of the liquid but not far enough to complete a full uptake (e.g., the full uptake being the assigned volume of liquid from method 600).

At 450, after steps 460 and/or 462, responsive to the processor 112 identifying the depth of tip 328 as over depth threshold and/or detecting the micropipette tip entry activation volume 326d interacting with container interaction volume 342a and/or that the tip 328 is under the liquid depth threshold, the processor instructs the user display 122 to display an error message. In one example embodiment, if the processor 112 identifies the depth of tip 328 as interacting with or entering the container 308 and/or interacting with the liquid therein, and subsequently exiting the container without up taking liquid, an error message is presented to the user. Continued from section line B-B in FIG. 4B, illustrated in FIG. 4E as continuing from section line B-B, steps 421 and 423 are completed.

Continued from section line C-C in FIG. 4B, illustrated in FIG. 4C as continuing from section line C-C, at 464, responsive to the processor 112 identifying the depth of tip 328 as over depth threshold and/or detecting the micropipette tip entry activation volume 326d interacting with container interaction volume 342a and that the tip 328 is over the liquid depth threshold, the processor determines if the user is interacting with tactile element 118 of the micropipette hand. The micropipette 322 has three definite positions. A resting position 332c that defines a volume of 100% of the operational capacity of the micropipette 322. The processor 112 will instruct the user display 122 to display the plunger 322a in the resting position 332c (e.g., fully extended away from the rest of the micropipette) absent interaction of the user with the tactile element 118. (see FIG. 3R1). Depression to a first stop 332a of the plunger 322a retains a same volume in the tip 328. In one example embodiment, liquid is either being dispensed when moving from the resting position 332c to the first stop 332b or extracted when moving from the first stop 332b to the resting position 332c. In one example embodiment, a state of the plunger 322a is displayed on a depression bar 327 that the processor 112 will instruct the user display 122 to display next to the micropipette 322 during tactile interaction with the tactile element 118 of the micropipette hand. (see FIG. 3P).

At 466, responsive to the processor 112 determining the user is interacting with tactile element 118 of the micropipette hand, the processor 112 instructs the user display 122 to show the micropipette plunger 322a depressing from the resting position 322c to the first stop 332a. (see FIGS. 3P-3R, 3R1). In one example embodiment, the interaction with the tactile element 118 comprises a rate of change and/or an actuation per second until an actuation threshold is reached. In one example embodiment, the rate of change is ideally 2 seconds from resting to fully actuated to generate an ideal dispensing speed. In another example embodiment, the rate of change is ideally fifty (50) percent of an actuation range of a tactile element 118 per second to generate the ideal dispensing speed. In one example embodiment, an actuation duration of two (2) seconds from the resting position 322c to the second stop 332b (e.g. fully actuated) or the second stop 332b (e.g. fully actuated) to the resting position 322c would generate the ideal dispensing or uptake speed, respectively. The uptake speed is the time it takes the measured liquid from the container 308 to completely enter the tip 328 and the dispensing speed is the time it takes the measured liquid from the tip 328 to completely enter the container 308 and/or centrifuge tube 350. The speed of the interaction may be applied at different rates, wherein rates over a bubble rate threshold (e.g., the tactile element 118 is fully actuated in 1 second or less) will result in the presentation of bubbly liquid and/or an error message as described at 421 and 423 in FIG. 4E. Note, it would be understood by one having ordinary skill in the art that both forward pipetting and backward pipette are supported herein. For example, forward pipetting is when liquid is uptaken when the plunger 322a is moved from the first stop 332a to the resting position 332c, then the micropipette 322 dispenses liquid until the plunger moves to the second stop 332b. Depressing the plunger 332a to the second stop 332b in forward pipetting is known as blow-out, to ensure no liquid droplets remains inside the tip 328. Reverse pipetting is when liquid is uptaken into the tip 328 when the plunger 332a is moved from second stop 332b to the resting position 332c, then tip dispenses the liquid when the plunger 322a moves to the first stop 332a.

Once the container 308 is open and the micropipette 322 is in the dispensing position, and the tip 328 is over the liquid depth threshold, and the tip 328 is over the depth threshold, and/or the micropipette tip entry activation volume 326d is interacting with the container interaction volume 342a a liquid transfer from the container 308 to the micropipette tip 328 can be begin. In another example embodiment, once the container 308 is open, and the micropipette 322 is in the dispensing position, and the micropipette tip entry activation volume 326d overlaps the container interaction volume 342a, a liquid transfer from the container to the micropipette tip 328 begins once the processor 112 receives a signal that the user is interacting with the plunger 322a as described below. The plunger 322a is operated by the tactile element 118. The relationship between the tactile element 118 position and the amount of liquid withdrawn or dispensed from the micropipette 322 is hereafter called the tactile element-liquid-curve. An example tactile element liquid-curve 360 is illustrated in FIG. 3R2.

In the tactile element liquid-curve 360, a y-axis represents a percent liquid capacity, an x-axis represents a percent trigger pulled, and a plotted line 333 represents the relationship therebetween. In this example embodiment, one hundred percent of an operation capacity of a given pipette 322 is reached at the first stop plateau 332a, and between the first stop plateau 332a and the second stop plateau 332b a ten (10) percent overage capacity is provided. The resting position 332c is illustrated at about 0% liquid capacity and extends between zero (0) to five (5) percent trigger pull. In this example embodiment, the controller 130 comprises a depressible trigger. Between the resting position 332c and the first stop 332a is illustrated between about zero (0) percent and one hundred (100) percent of the operational capacity and extends between five (5) to fifty (50) percent trigger pull. In one example embodiment, when moving from the first stop 332a to the resting position 332c, the processor 112 instructs the user display 122 to show the tip 328 of the micropipette 322 continuously uptaking liquid. The first stop 332a plateau is illustrated at about one hundred (100) percent operational capacity and extends between forty seven (47) to ninety (90) percent trigger pull. While up taking liquid, the full operational volume (e.g., the volume on the volume display 322b on the micropipette) of liquid will be present in the tip 328 at the resting position 332c plateau. Between the first stop 332a and the second stop 332b is illustrated between about zero (0) percent and one hundred (100) percent overage liquid capacity and extends between ninety (90) to ninety seven (97) percent trigger pull.

During dispensing of the liquid, between the resting position 332c and the first stop 332a, the processor 112 instructs the user display 122 to show the tip 328 of the micropipette 322 dispensing about ninety five (95) percent of the total operational volume to be dispensed

As the tactile element 118 is actuated from the resting position 332c to the first stop 332a, the processor 112 instructs the user display 122 to show the tip 328 of the micropipette 322 dispensing the corresponding amount of additional liquid per frame, as is determined by the change in position of the tactile element 118 along the x-axis of the percent actuation of the tactile element.

Stated another way, approximately ninety five (95) percent of the liquid in the tip 328 is dispensed from the resting position 332c to the first stop 332 a (e.g., leaving about five (5) percent of the liquid in the tip 328 to be dispensed during the clink).

As illustrated in the plotted line 333 of FIG. 3R1, the value from the first frame 333a to the second frames 333b on the x-axis is about five (5) percent. This increase of five (5) percent on the x-axis along the plotted line 333 correlates to an increase on the y-axis of approximately thirteen (13) percent of the total operational liquid capacity. Thus, the second frame 333b illustrates a volume dispensed that is approximately the value of the difference between the first frame 333a and the second frame 333b along the y-axis of the total volume in the tip 328 is dispensed at the second frame 333b.

Stated another way the equation (equation 1) is:

(Delta on the y-axis)/(y-axis range from resting position 332c to the first stop 332a=the percentage of the transfer between the resting position 332c and the first stop 332a that has been dispensed.

In one example embodiment, the result of equation 1 is used to calculate the percent of the total transfer volume that has been dispensed, by multiplying the result of equation 1 by a scalar that represents the operational capacity which is the transfer to be completed at the first stop 332a (e.g., which in the current embodiment is ninety five (95) percent of the operational capacity). For example, where the operational capacity or volume is set to 500 uL the processor 112 would determine a scalar of 500*95% which would equal 475 uL)

In one example embodiment, when moving from the first stop 332a to the second stop 332a, the processor 112 instructs the user display 122 to show the tip 328 of the micropipette 322 dispensing liquid. In another example embodiment, moving from the first stop 332a to the second stop 332a, the processor 112 instructs the user display 122 to show the tip 328 of the micropipette 322 dispensing any remaining overage liquid which is at maximum equals ten (10) percent of the operational capacity. This remaining volume is dispensed in the same fashion as described in above (e.g., the remaining volume of liquid).

At 470, responsive to ceasing tactile element 118 interaction after achieving the actuation threshold, the processor 112 instructs the user display 122 to show the micropipette plunger 322a extending to the resting 332c position and liquid being continuously uptaken into tip the 328. The processor 112 generates an image of a continuous liquid transfer from the container 308 into the tip 328 of the micropipette 318. Continuous in this case is defined as liquid transfer in small increments proportional to the change of the tactile element 118 or tactile element 118 position of the controller 130 holding the micropipette (e.g., the rate actuation of the tactile element 118 is applied). For example, if the tactile element 118 is actuated more rapidly than the ideal uptake speed (e.g., a greater actuation is applied over less time), the liquid will be uptaken faster, if the actuation is applied more slowly than the ideal uptake speed (e.g., a lesser force is actuation over more time), the liquid will be uptaken more slowly. In one example embodiment, the ideal uptake speed is volume dependent. In another example embodiment, the ideal uptake speed is between 3 seconds to 5 seconds. The relationship between the amount of liquid that should be in the attached tip 328 and where the tactile element 118 position currently rests is defined by the customizable tactile element-liquid curve. Events that signal the controller's 130 tactile element 118 position has changed are propagated through sensors 116, and the processor 112 determines how the micropipette 318 reacts to those tactile element 118 change events and calculate the proportions of liquid that need be transferred into or out of the attached tip 328 on the frame that tactile element 118 change event occurs; this calculation depends largely on the custom tactile element liquid curve. The custom tactile element liquid curve equation utilizes an input value from the tactile element 118 as a value between the range of not pulled to completely pulled, or not fully actuated to completely actuated and applying that value to a curve to identify the correct transfer volume. In the most basic version this would be a linear graph that has a slope of 1. In one example embodiment, when the tactile element 118 is compressed 25% the volume would be 25% of the operational capacity and when the tactile element 118 is depressed 90% the volume would be 90%. There is the ability to overdraw which means that the tactile element 118 compression is not linearly converting the pull percentage to a range of operational capacity of 0 to 100% but rather mapping to a range of 0 to 110%. In another example embodiment, the processor 112 will customize the tactile element liquid curve 360 and its supporting functions to overdraw to any positive percentage of the operational capacity (e.g., [0, 3.402 E+38] (max signed 32 bit floating point value)). As the user pulls/depresses the tactile element 118 on the controller 130, liquid is dispensed from the attached tip 328 in increments as described above. As the user releases the tactile element 118 on the controller 130 liquid is pulled into the tip 328 in increments as described above.

At 472, between steps 470-488 the processor 112 is monitoring to identify if the user tilts sensor 116 of the micropipette hand over a tilt threshold. In one example embodiment, the tilt threshold is wherein the pipette hand is tilted over 45° from vertical. At 468, responsive to the processor 112 identifying that the sensor 116 of the micropipette hand is over the tilt threshold, the processor 112 provides an error message to restart at step 412 after discarding the impacted tip 328 as described in later method steps. Continued from section line A-A in FIG. 4C, illustrated in FIG. 4A as continuing from section line E-E, steps are resumed at 412.

In one example embodiment, the tip 328 having liquid present therein, is intended to be transferred to the centrifuge tube 350. As illustrated in FIGS. 3S-3T, the centrifuge tube 350 has a tube top 350a and a tube body 350b. To remove the tube top 350a of the centrifuge tube 350 or open the tube top, while the tube top remains connected to the centrifuge tube, method steps 440-442 are repeated, except that the user interacts with a tube top interaction volume 352a rather than the container cap interaction volume 342. In this example embodiment, both the micropipette hand and the non-micropipette are capable of opening the centrifuge tube 350. Further, if the non-micropipette hand picks up the centrifuge tube 350, then the micropipette hand is the only hand able to open the tube top 350a.

At 474, responsive to the processor 112 detecting from the sensor 116 that the tip activation volume 326c is in a centrifuge tube activation volume 352 of an open centrifuge tube 350, the processor 112 instructs the user display to show the tip 328 in the dispensing position in the open centrifuge tube. (see FIG. 3U). In one example embodiment, the centrifuge tube activation volume 352 is a defined area over and inside the tube body 350b. At 476, responsive to showing the tip 328 in dispensing position, the processor 112 instructs the user display to generate a magnified tip view 354. (see FIG. 3V). Note, it would be understood that the micropipette 322 interacting with the tip 328, the tip interacting with one of the container 308 or the centrifuge tube 350 could be shown as the magnified tip view 354.

In some example embodiments, to aid in the visual perception of very small interactions, the processor 112 will present the micropipette 322 in a small zoomed in view of the tip 328 when the tip enters an activation volume (e.g., the magnified tip view 354). (see FIG. 3V). In this example embodiment, the user display 122 does not display the activation volumes 328a, 342, 342a, 352, 312a. Rather the respective activation volumes 328a, 342, 342a, 352, 312a, are intuitively the zone in which the tip 328 would need to be placed to interact with the contents of various containers. In one example embodiment, the processor 112 uses an element of head tracking meaning that it is only visible once the items are within a certain range of the user's head so that it only appears when it is visible and useful to the user. The processor 112 monitors if the tip 328 has entered a particular activation volume 328a, 342, 342a, 352, 312a and then it will spawn or make visible a plane with a texture that looks like a magnified view of the area within the plane. Stated another way, the magnified tip view 354 allows the user to more easily see what they are doing when they need to do manipulations of very small volumes.

At 478. responsive to detecting the tip activation volume 326c leaving the centrifuge tube activation volume 352, the processor 112 instructs the user display 122 to show the tip 328 uncoupled from dispensing position and ceases presenting the magnified tip view 354. Step 478 may occur at any point during steps 474, 476, 482, 484.

The micropipette's 322 tactile element liquid curve has two distinct ranges which define volume deltas proportional to the micropipette's operational capacity. These volume deltas are calculated from the resting position 332c to the first stop 322a defined as a first volume delta and the first stop 322a to the second stop 322b defined as a second volume delta. In one example embodiment, the first volume delta and the second volume delta are the same. In another example embodiment, the first volume delta and the second volume delta are different. The first volume delta is equal to 100% of the micropipette's 322 operational capacity. In one example embodiment, the second volume delta is equal to 10% of the micropipette's 322 operational capacity. The difference between the first stop to second stop volumes is that liquid is dispensed from the first stop 322a to the second stop 322b, while liquid is pulled into the attached tip 328 from the second stop 322b to the first stop 322a. The full operational capacity of the micropipette 322 will be dispensed by moving from the resting position 332c to the second stop 322b. The volume of liquid transferred into the empty tip 328 if the user releases the tactile element 118 from the second stop 322b to the rest position 322c can be 110% of the micropipette's 322 operational capacity. Similarly, that same 110% of the operational capacity is dispensed when the user pulls the tactile element 118 from resting position 322c to the second stop 322b.

For example, as the user depresses the tactile element 118 (which is analogous to the plunger 322a), the processor 112 implements speed tracking. If the user depresses the tactile element 118 too quickly, which would increase the chance of generating bubbles in the physical world, the processor 112 will generate an error alerting the user that they are executing poor pipetting and/or it can be a scored criteria. In another example embodiment, an inverse of the ideal speed and force application for uptaking the liquid at steps 466, 470 is utilized to dispense the liquid (e.g., force applied to the tactile element 118 is lessened over time rather than increased).

After the user makes this error they may be prompted to reattempt the liquid transfer or they may just receive a failed criteria on their scoring. At 480, the processor 112 monitors to detect if the user is interacting with the tactile element 118 of the micropipette hand while the tip 328 is in the dispensing position. At 482, responsive to the processor 112 detecting that the user is interacting with the tactile element 118 of the micropipette hand while the tip 328 is in the dispensing position, the processor 112 instructs the user display 122 to show the micropipette plunger 322a depressing to the first stop 332a. In one example embodiment, the processor 112 will generate an error message if the user is interacting with the tactile element 118 over the bubble rate threshold.

In one example embodiment, prior to depressing the plunger 322a to the second stop 332b, the liquid may be mixed. In this example embodiment, the processor 112 generates a laboratory environment wherein the user can replicate the real-world process used to mix small volumes using the micropipette 322. In this example embodiment, the user will be instructed to set the volume on the micropipette 322 to a volume that is approximately half the total volume of the liquid to be mixed. The user then depresses the tactile element 118 to the first stop before submerging the tip 328 of the micropipette 322 into the target liquid. The user may then actuate the tactile element 118 allowing micropipette 322 to draw up the liquid. An error message is generated if the tip 328 does not remain submerged in the liquid. The depression of the tactile element 118 and subsequent release below the actuation threshold, which causes the micropipette 322 to revert to the resting position 322c, causes the liquid to be mixed. After several cycles (e.g., 3) the user then depresses the tactile element 118 to the second stop 332b (e.g., fully depressing the plunger 322a) before removing the tip 328 from the now mixed liquid. The processor 112 displays the liquid as now in a mixed state.

At 484, responsive to continued tactile element 118 interaction over the first dispensing threshold, the processor 112 instructs the user display 122 to show the micropipette plunger 322a depressing to a second stop 332b and liquid dispensing from tip 328 into centrifuge tube 350, the processor 112 instructs the user display 122 maintain a clink volume in tip 328. In one example embodiment, the first dispensing range is an increasing percentage of trigger pull between five (5) percent to fifty (50) percent at a rate of ten percent pull per second. In another example embodiment, the first dispensing range is an increasing trigger pull between five (5) percent to fifty (50) percent applied for any time duration.

At 486, responsive to the processor 112 not detecting that the user is interacting with the tactile element 118 of the micropipette hand while the tip 328 is in the dispensing position, the processor 112 instructs the user display to maintain magnified tip view 354. In one example embodiment, the magnified tip view 354 will be displayed anytime the tip 328 is in the dispensing position.

Continued from section line D-D in FIG. 4C, illustrated in FIG. 4D as continuing from section line D-D, at 487, responsive to detecting continued tactile element 118 interaction after dispensing, the processor 112 instructs the user display 122 to continue to display the plunger 332a depressed to the second stop 332b. In another example embodiment, responsive to the processor 112 detecting continued tactile element 118 interaction after dispensing the liquid, the processor generates an error message.

At 488, responsive to gradually ceased tactile element 118 interaction within the ideal rate of change, the processor 112 instructs the user display 122 to display the plunger 332a returning to the resting position 332c. In one example embodiment, responsive to the cessation of tactile element 118 interaction being outside the ideal rate of change (e.g., the interaction being not sufficient to trigger a liquid uptake or dispensing and/or too fast), the processor 112 instructs the user display 122 to show an error message.

At 490, the processor 112 monitors if the user interacts with the tactile element 118 of the micropipette hand and/or moves the sensor 116 of the micropipette hand with a clink motion. At 492, responsive to the processor 112 detecting that the user is interacting with the tactile element 118 of the micropipette hand and moves the sensor 116 of the micropipette hand with the clink motion, the processor 112 instructs the user display 122 to show the clink volume removed from tip 328. Note, steps 474-492 would be used to dispense liquid into various containers, not just centrifuge tubes 350.

Stated another way, once any volume of liquid has been dispensed from the tip 328 of the micropipette 322, the clink technique is implemented. In addition to the continuous liquid transfer and volume deltas, after any amount of liquid is dispensed from the micropipette 322, the micropipette will reserve a small volume of liquid equal to 5% of its operational capacity. It would be understood that the reserved small volume of liquid can be assigned by the processor 112. This volume is the clink volume that will remain in the micropipette 322 until such time that the user performs the correct clink technique. The clink technique is used to dispense the reserved 5% of liquid from the micropipette 322, it can be performed after any amount of liquid has been dispensed from the micropipette 322 as described above. For example, if the user dispenses 0.01 μL then the processor 112 will internally expose the clink volume and allow the clink technique to occur, even if the micropipette 322 still contains 80% of its operational capacity. After performing the clink technique, the micropipette 322 will contain 75% of its operational capacity, and the processor 112 will disallow the clink technique again until such time that more liquid is dispensed. In one example embodiment, an automatic clink is performed responsive to the tip 318 being over the liquid depth threshold and the plunger 322a being depressed to the second stop 332b. Wherein the automatic clink is performed, no liquid is retained in the tip 328.

The processor 112 monitors the tips 328 position and rotation so that the processor 112 has an accurate representation of the angle manipulations that are executed by the user when expelling the volume. The importance of the rotation is the angle of deflection relative to the up vector of the container 308 and/or the centrifuge tube 350 (e.g., relative to a container). Essentially the processor 112 can infer if the user has touched or even dragged the tip 328 of the micropipette 322 to the side of the container 308 based on the angle or tilt of the micropipette as determined by the sensor 116 location. In one example embodiment, the tip activation volume 326c overlapping one of several clink interaction volumes (not shown) that are positioned as a shell/hull around the edges of a container 308, vial, or centrifuge tube 350 would signal a completion of the clink technique. In this example embodiment, if any overlap of said volumes occur, then the clink technique has been executed.

The clink mechanic is designed to represent the additional action required to dispel the final drop of liquid from the micropipette tip 328. So the act of clinking is not a goal of the user but rather it is a necessary final step of a dispense in order to ensure the entire volume of liquid has been dispensed. The processor 112 does not communicate to the user how to enable an additional clink, but rather the user should be able to see that there is still liquid in the micropipette 322 and deduce they have not successfully dispensed all the liquid. The processor 112 monitors for this situation and will notify the user via an error message that they failed to completely dispense the full volume and require them to reattempt that aliquot.

The clink technique is executed as follows. The user begins by moving the micropipette tip 328 into the one or more tube activation volumes (e.g., a centrifuge tube 350). The processor 112 begins tracking the micropipette tip's 328 position and rotation relative to the center of a respective containers of the one or more activation volumes.

To clarify the rotation is a deflection from a centrifuge vertical axis CVA that runs from the bottom of the centrifuge tube 350 to the open top. (see FIG. 3T). For example, it is the same as a tilt the user would use if the user were to be manipulating a joystick. In one example embodiment, the centrifuge vertical axis CVA can run in multiple directions so long as it is possible that the tip 328 of the micropipette 322 touches the side of the centrifuge tube 350, or other container.

The user finishes by lifting and rotating the micropipette tip 328 out of the respective tube activation volume 352, such as described at 456, and 478, and/or via the tip activation volume 326c overlapping one of several clink interaction volumes. The processor 112 determines the difference in position and rotation from entering to exiting the respective tube activation volumes. If the position and rotation changes are greater than pre-defined minimums, then the clink volume is dispensed. Stated another way, the changes the processor 112 monitors are the change in the angle and position relative to the angle and position with which that the tip 328 entered the centrifuge tube 350. The processor 112 monitors and stores the values correlating to the angle and position of the tip 328 as the entrance and exit values.

At 472, the processor 112 determines that the sensor 116 of the micropipette hand is over the tilt threshold. Note, the rotation for the clink volume removal is less than the tilt threshold. Responsive to the sensor 116 detecting that the user has exceeded the tilt threshold, the processor 112 proceeds to step 468 described above.

At 494, the processor monitors if the tip activation volume 326c enters the waste bag activation volume 312a with the micro-pipette hand. (see FIG. 3X). At 499, responsive to the processor detecting entry of the non-micro-pipette hand, a micropipette 322 without a tip 328, a tip full of liquid entering the waste bag activation volume 312a, and/or any other tip contamination activity occurring, the processor instructs the user display 122 to display an error message. Continued from section line B-B in FIG. 4B, illustrated in FIG. 4E as continuing from section line B-B, steps 421 and 423 are completed.

At 496, responsive to the processor detecting that the tip activation volume 326c entered the waste bag activation volume 312a with the micro-pipette hand, the processor monitors to determine if the user interacts with the tactile element 118 of the micropipette hand. At 989, responsive to the processor determining that the user interacted with the tactile element 118 of the micropipette hand, the processor 112 instructs the user display 122 to show the tip 328 decoupled from the micropipette 328 and released into the waste bag 312.

### Micropipette Volume Simulation 500

As illustrated in FIG. 6A, a method 600 of use of the virtual reality system 100 with the interactive micropipette volume simulation 500 is illustrated. Features of the micropipette simulation 300 illustrated in FIGS. 3A-3X that are similar to the features of the micropipette volume simulation 500 illustrated in FIGS. 5A-5E will be identified by like numerals increased by two-hundred. At 602, the processor 112 receives a signal indicating the user has selected the pipette 522 base upon the pipette size (see FIGS. 5A-5B). The volume display 522b on the micropipette 522 allows a user to view the operational capacity of the micropipette 522. The processor 112 will instruct the user display 122 to display the operational capacity ranges of various micropipettes sizes. As illustrated in the example embodiment of FIGS. 5A-5B, the user is presented with a selection of a P2 (e.g., having an operational capacity between 0.5 ul-2.0 ul), P20 (e.g., having an operational capacity between 2 ul-20 ul), P200 (e.g., having an operational capacity between 20 ul-200 ul), and P1000 (e.g., having an operational capacity between 100 ul to 1000 ul). In one example embodiment, the processor 112 receives a signal from the sensor 116 that the user has selected pipette 522 based upon a transfer volume displayed on the user display 122. An error message is generated if the user selects a micropipette 322 that is not the smallest micropipette that still has an operational capacity that encompasses the transfer volume. At 604, the processor 112 determines that steps 412-416 of method 400 of FIG. 4A were performed such that the user has “picked up” the micropipette 522 and acquired a tip 528. Responsive to steps 412-416 of method 400 of FIG. 4A having been performed, at 606 the sensor 116 detects motion. At 608, as illustrated in the example embodiment of FIG. 5D, responsive to the processor 112 detecting motion of non-pipette hand in the plunger volume activation volume 560, at 610, the processor 112 generates an enhanced view of the plunger 522a. In one example embodiment, the enhanced view includes arrows indicating rotation of the plunger 522a. In another example embodiment, the enhanced view includes generating images showing rotation of the plunger 522a. In another example embodiment, the enhanced view includes instructions on how to actuate the tactile element 118 to alter the volume of the micropipette 522 (e.g., move finger or thumb counter-clockwise to increase volume and/or move finger or thumb clockwise to decrease volume). At 612, the tactile element 118 detects motion, and identifies a directionality and/or speed of the detected motion. At 614, responsive to the tactile element 118 detecting a first directional motion (e.g., counter-clockwise), the processor 112 generates image of the micropipette 322 with an increasing volume. In one example embodiment, a speed at which the volume increases, as illustrated by the number in the volume display 522b, is proportional to a speed of the first directional movement. At 618, responsive to first directional motion exceeding a pipette volume threshold (e.g., the operational capacity assigned to the micropipette 522), the processor 112 provides error message. (see FIG. 5E).

At 616, responsive to the tactile element 118 detecting a second directional motion (e.g., clockwise or opposite the first directional motion), the processor 112 generates image of the micropipette 322 with a decreasing volume. In one example embodiment, a speed at which the volume decreases, as illustrated by the number in the volume display 522b, is proportional to a speed of the second directional movement. At 620, responsive to the second directional motion dropping below a pipette minimum volume threshold (e.g., below the operational capacity assigned to the micropipette 522), the processor 112 provides an error message. (see FIG. 5E). At 622, responsive to either the first or second directional motion reaching the set volume, the processor 112 generates image of the micropipette 522 with a volume number in the volume display 522b that matches the set volume number. At 624, the method is resumed either at 440 of method 400 in FIG. 4B, or at 830 of method 800 in FIG. 8B.

### Multichannel Micropipette Simulation 700

As illustrated in FIGS. 8A-8D, a method 800 of use of the virtual reality system 100 with the interactive multichannel micropipette volume simulation 700 is illustrated. Features of the micropipette simulation 300 illustrated in FIGS. 3A-3X that are similar to the features of the multichannel micropipette simulation 700 illustrated in FIGS. 7A-7L will be identified by like numerals increased by four-hundred.

At 802, the processor 112 receives a signal indicating the user has selected the interactive multichannel micropipette simulation 700 (see FIG. 7A-7L). At 804, the processor 112 generates the multichannel micropipette simulation 700, including generating an image of a multichannel micropipette 722 and instructs the user display 122 to display the multichannel micropipette simulation.

At 806, the processor 112 generates and instructs the user display 122 to display an initial multichannel micropipette view. The initial multichannel micropipette view is substantially the same as the initial micropipette view 330, except the initial multichannel micropipette view comprises the multichannel micropipette 722, a trough 715, and a well plate 714. In the illustrated example embodiment, the well plate 714 includes a plurality of individual wells that can receive an aliquot. In one example embodiment, the well plate 714 includes 96 individual wells. As illustrated in the example embodiments of FIGS. 7A-7B, 7E and 7F, the multichannel micropipette 722 illustrates a multichannel micropipette as presented in the real world. In this embodiment, the sensor 116 sends a signal to the processor 112 that the controller 130 is within an activation volume 726a, 726b, 726c, 728a, (trough activation volume) 742, (well plate activation volume) 752, 712a. At 808, the processer 112 generates and instructs the user display 122 to display micropipette components 718. (see FIG. 7C). The micropipette components 718 include the tip box 704, the well plate 714, one or more containers (not shown), a waste bag 712, the trough 715, and/or the multichannel micropipette 722 (see, for example, FIGS. 7C-7D, 7G-7L). Steps 804-810 may be performed in any order, and/or may be performed simultaneously. In the example embodiment, the micropipette components 718 are supported by a lab bench 701. (see FIG. 7C).

At 810, the processor 112 designates a micropipette activation volume 726, a micropipette grip activation volume 726a, a micropipette tip activation volume 726b, (see FIG. 7A), a micropipette tip dispensing activation volume 726c (see FIG. 7E), a tip interaction volume 728a, a trough interaction volume 742 (see FIG. 7C), an aliquot activation volume 752 (see FIG. 7J), a waste bag activation volume 712a (see FIG. 7L), and/or other sample stimulation machine volumes in Cartesian coordinate systems corresponding to the tip box 704, the well plate 714, the trough 715, the waste bag 712, the multichannel micropipette 722, and/or the other sample stimulation machines. In this example embodiment, the activation volumes 726, 726a, 726b, 726c, 728a, 742, 752, 712a are the same or similar to the activation volumes described above. In another example embodiment, each well of the well plate 714 has an individual well activation volume 752a. (see FIG. 7J1).

At 812, the sensor 116 detects motion. At 814, the tip box 704 is opened as in steps 412-418 in method 400 of FIG. 4A. At 818, the sensor 116 detects motion of the tip activation volume 726b of the multichannel micropipette 722 in the tip box interaction volume 728a outside a z-axis alignment threshold. Note, in one example embodiment, whenever the tip activation volume 726b interacts with the tip box interaction volume 728a, the magnified tip view 754 (illustrated in FIG. 7K) is presented on the user display 122. As shown in the illustrated example embodiment of FIG. 7D, the z axis alignment threshold is a deviation over a z axis angle 721b of a micropipette axis MPA, as illustrated in FIG. 7A, from an alignment axis 720 along a z direction. The alignment axis 720 runs parallel to the rows 720a, 720b, 720c of the tips 728. (see FIG. 7D). The z axis alignment threshold represents the deviation allowed in the real world for proper tip 728 application to the multichannel pipette 722. In one example embodiment, the z axis angle 721b is between 1° and 15°. At 820, responsive to the micropipette 722 in the tip box interaction volume 728a being outside the z axis alignment threshold, the processor 112 provides an error message at B-B. Continued from section line B-B in FIG. 8A, illustrated in FIG. 8E as continuing from section line B-B at 821 an error message stating the specific error is generated by the processor 112 and presented to the user. At 823, the processor 112 provides instruction on how to continue, including proceeding to any of the recited method steps of the method 800.

At 822, the sensor 116 detects motion of the tip activation volume 726b of the multichannel micropipette 722 in the tip box interaction volume 728a outside a y-axis alignment threshold. As shown in the illustrated example embodiment of FIG. 7D, the y axis alignment threshold is a deviation over a y axis angle 721a of the micropipette axis MPA, as illustrated in FIG. 7A, from the alignment axis 720 along a y direction. The y axis alignment threshold represents the deviation allowed in the real world for proper tip 728 application to the multichannel pipette 722. In one example embodiment, the y axis angle 721a is between 1° and 15°. In another example embodiment, the y axis angle 721a is between plus or minus 15°. At 824, responsive to the sensor 116 detecting motion of the tip activation volume 726b of the multichannel micropipette 722 in the tip box interaction volume 728a outside the y-axis alignment threshold, the processor 112 generates an image of the multichannel micropipette 722 with an incomplete tip 728 attachment proportional to a degree the tip box interaction volume 728a is outside y-axis alignment threshold. In one example embodiment, if the y axis angle 721a is about 10° then about half of the tips 728 will be illustrated as attached to the multichannel micropipette 722 on a first side of the multichannel micropipette 722. The first side of the multichannel micropipette 722 is opposite a second side of the multichannel micropipette along micropipette axis MPA. The first side is the side that is angled away from the alignment axis 720 along the y axis. In another example embodiment, if the y axis angle 721a is about 5 then about three quarters of the tips 728 will be illustrated as attached to the multichannel micropipette 722. In another example embodiment, if the y axis angle 721a is about 12° then about a quarter of the tips 728 will be illustrated as attached to the multichannel micropipette 722. In yet another example embodiment, if the y axis angle 721a is 15° or above then one of the tips 728 will be illustrated as attached to the multichannel micropipette 722. Additionally, the downward force of the tip 328 application effects how many tips are successfully applied. Just like in the physical world, responsive to the sensor 116 detecting that the y axis angle 721a is within an approximately 0°-15° range, responsive to the user applying sufficient downward force the multichannel micropipette 722 will illustrate all the tips 728 are successfully applied. Similarly, as in the real world, successful tip 728 application to the multichannel micropipette 722 it is a combination of the y axis angle 721a and the downward force applied.

In one example embodiment, the downward force is determined using a combination of a measure of speed (which is accomplished using a weighted average of the downward speed of micropipette hand controller 116), and a representation of force (which is determined based on how far below an initial point of contact (e.g., entrance into the tip box activation volume 705) the controller travels into and below the tip box 704. In this example embodiment, the micropipette hand controller 116 traverses a distance from where the micropipette 728 initially begins to enter into the dispensing position (e.g., approximately two (2) inches from contact with the tips 728) to the tip box 704 in one (1) second. In one example embodiment, applying sufficient downward force is accomplished, wherein, responsive to the tip activation volume 726b of the micropipette 728 having reached the tip box 704, the micropipette hand controller 116 continues down passed the initial point of contact by more than a quarter inch, but less than 1 inch.

At 820, responsive to the tip activation volume 726b of the multichannel micropipette 722 being in the tip box interaction volume 728a and being outside the y axis alignment threshold, the processor 112 provides an error message at B-B. Continued from section line B-B in FIG. 8A, illustrated in FIG. 8E as continuing from section line B-B, steps 821 and 823 are completed. In one example embodiment, the error message is provided before step 824. In another example embodiment, the error message is provided after step 824, and the error message includes instruction to inspect the tips 728.

Stated another way, the processor 112 instructs that constraints be added to the multichannel micropipette 722, which work in concert with the standard single-channel micropipette 322 constraint described above in method 400 of FIGS. 4A-4E. Such constraints occur when the user approaches the correct size tips. The processor 112 checks the relative rotation and relative position of the multichannel micropipette 722 to ensure the user is positioned and rotated such that all tip application points align with all available tips 728 in a row of the tip box 704 (e.g., align the micropipette axis MPA with the alignment axis 720). In one example embodiment, the angle used to push the multichannel micropipette 722 down onto the tips 728 need not be perfectly perpendicular as there is a tolerance beyond perfectly perpendicular to the tip box 704. If the user is not correctly aligned to simultaneously apply all tips 728, then an error message instructs the user of correct tip-application technique. In addition, once a single tip 728 from an arbitrary row of the tip box 704 is applied to the multichannel micropipette 722, all subsequent tips must be from that same tip box row. The processor 112 allows the user to apply tips 728 from a new row if they discard all tips from the multichannel micropipette 722.

The processor 112 will detect if the user looks at the tips 728 of the multichannel micropipette 722. Thus, allowing the processor 112 to enter instructions that at given points in time the user must inspect the tips 728 of the multichannel micropipette 722 before continuing. There is a frustum cone or a rectangular prism frustum that the processor 112 calculated from the root of the headset 120 out in the direction of the headset to imitate the field of view of the user. If the multichannel micropipette 722 is held within this region and within a given distance to the headset 120, the processor 112 will record the tips 728 as being inspected. In one example embodiment, the processor 112 will record the tips 728 as being inspected tips, when the tips 728 are perpendicular to the direction of a view of the headset 120, such that all tips are clearly visible and the volumes in each can be inspected as well (e.g., such as after liquid uptake in step 862). The processor 112 will determine a duration of inspection needed to record the tips 728 as being inspected tips. In one example embodiment, the duration of inspection is between 1 second and 15 seconds.

At 816, the sensor 116 detects motion of the tip activation volume 726b of the multichannel micropipette 722 in the tip box interaction volume 728a within the z axis alignment threshold and the y axis threshold. At 828, responsive to the sensor 116 detecting motion of the tip activation volume 726b of the multichannel micropipette 722 in the tip box interaction volume 728a within the z-axis alignment threshold and the y axis threshold, the processor 112 generates an image of the multichannel micropipette 722 with tips 728 attached to each of the barrels 722d. (see FIG. 7E)

Continued from section line A-A in FIG. 8A, illustrated in FIG. 8B as continuing from section line A-A, described in detail in method 600, and FIGS. 5A-5E, a volume of the multichannel micropipette 722 is set. At 830, a container cap (not shown) is removed from the container as described in steps 440-448. At 832, the sensor 116 detects movement of a hand coupled to the container, and illustrates liquid from the container being poured into the trough 715. In one example embodiment, step 832 is performed by the processor 112 without user input.

At 834, the sensor 116 detects motion. At 836, the sensor 116 detects motion of the tip activation volume 726b of multichannel micropipette 722 in the trough activation volume 742 outside the z axis alignment threshold. (see FIG. 7G). Note, in one example embodiment, whenever the trough activation volume 742 interacts with the multichannel micropipette tip interaction volume 726c, the magnified tip view 754 (illustrated in FIG. 7K) is presented on the user display 122. In this example embodiment, the z and y axis thresholds and the z and y axis angles 721b, 721a are relative to the alignment axis 720, which extends along the trough 715 defining an axis that allows the multichannel pipette 722 to uptake liquid. In another example embodiment, the alignment axis 720 bisects a long axis of the trough 715. At 838, responsive to the multichannel micropipette 722 trough activation volume 742 being outside the z axis alignment threshold, the processor 112 provides an error message at B-B. Continued from section line B-B in FIG. 8B, illustrated in FIG. 8E as continuing from section line B-B, steps 821 and 823 are completed.

At 844, the sensor 116 detects motion of the tip activation volume 726b of multichannel micropipette 722 in the trough activation volume 742 outside the y axis alignment threshold. (see FIG. 7G). In an optional step, at 838, responsive to the multichannel micropipette 722 trough activation volume 742 being outside the y axis alignment threshold, the processor 112 provides an error message at B-B. Continued from section line B-B in FIG. 8C, illustrated in FIG. 8E as continuing from section line B-B, steps 821 and 823 are completed.

At 846, the processor 112 instructs the user display 122 to show tips 728 entering the trough 715 at an angle proportional to a degree the tip activation volume 726c is outside the y axis alignment threshold (e.g., the first side of the multichannel pipette 722 will be farther from the trough 715 than the second side along the y direction). Stated another way, less than all of the tips 728 will be displayed as within the trough 715 and/or within the liquid in the trough. In another example embodiment, some tips 728 will be displayed as relatively deeper within the trough 715 and/or within the liquid in the trough, while others will be displayed as relatively shallower within the trough 715 and/or within the liquid in the trough.

At 842, the sensor 116 detects motion of the tip activation volume 726b of multichannel micropipette 722 in the trough activation volume 742 within the z and y axis alignment thresholds. At 488, the processor 112 instructs the user display 122 to show the tips 728 entering the trough 715 and having a consistent depth within the trough 715.

Continued from section line C-C in FIG. 8B, illustrated in FIG. 8C as continuing from section line C-C, at 850, continued from both 846 and 848, and illustrated in FIGS. 7G-7H, the processor 112 instructs the user display 122 to show the tips 728 in the dispensing position responsive to the tip activation volume 726c being within the trough activation volume 742 and/or within the trough activation volume 742 and outside the y axis alignment threshold. The dispensing position in this embodiment, includes the processor 112 instructing the user display 122 to show the multichannel pipette 722 extending along the vertical axis, along the dispensing axis, and/or the tips 728 having a magnetic attraction to the trough 715. The processor 112 instructing the user display 122 to show the multichannel micropipette 722 in the dispensing position does not alter the y axis angle 721a of the multichannel micropipette 722 relative to the trough 715.

At 852, responsive to detecting the tip activation volume 726c leaving the trough activation volume 742, the processor 112 instructs the user display 122 to show the tips 728 uncoupled from the dispensing position. Note, step 852 may be completed any time the tip activation volume 726c is within the trough activation volume 742. In one example embodiment, such as where the processor 112 instructs the user display 122 to display the magnified tip view 754 whenever the tip activation volume 726c enters the trough activation volume 742, the completion of step 852 will cause the processor 112 to remove the magnified tip view.

At 854, the processor 112 calculates the tip 728 depth in the trough 715. In this example embodiment, the tip 728 depth is calculated for each tip individually. In one example embodiment, the tip 728 depth is dependent upon the y axis angle 721a. In this example embodiment, if the y axis angle 721a is about 15° then a depth of about one fourth of the tips 728 on the first side of the multichannel micropipette 722 will be illustrated as partially or unsubmerged in the liquid in the trough 715. In another example embodiment, if the y axis angle 721a is about 20° then about half of the tips 728 on the first side of the multichannel micropipette 722 will be illustrated as partially or unsubmerged in the liquid in the trough 715. In another example embodiment, if the y axis angle 721a is about 35° then about a three quarters of the tips 728 on the first side of the multichannel micropipette 722 will be illustrated as partially or unsubmerged in the liquid in the trough 715. In yet another example embodiment, if the y axis angle 721a is 45° or above then one of the tips 728 will be illustrated as submerged within the liquid of the trough 715.

At 856, the processor 112 identifies the depth of the tips 728 as under a depth threshold. In this example embodiment, the tips 728 are under the liquid threshold when not one tip 728 has broken the plane of the liquid, and/or less than at least 1 cm of the tip has been submerged. The tips 728 are over the depth threshold when at least one tip 728 has broken the plane of the liquid, and/or at least 1 cm of the tip has been submerged. In one example embodiment, the liquid threshold is a dynamic threshold and not a static threshold. Stated another way, a volume of liquid in the trough 715 is reduced as liquid is up taken, and the volume shrinks, and thus the liquid threshold raises (e.g., the depth that the tip 728 must achieve within the trough 715 gets greater) to match the remaining volume of liquid available in the trough.

At 858, responsive to the depth of the tips 728 being under the depth threshold, the processor 112 provides an error message at B-B. Continued from section line B-B in FIG. 8C, illustrated in FIG. 8E as continuing from section line B-B, steps 821 and 823 are completed.

At 860, the processor 112 identifies the depth of at least one tip 728 as over the depth threshold. At 862, the multichannel pipette 722 uptakes liquid as in steps 464-470 of the method 400 in FIG. 4C.

In one example embodiment, illustrated herein there is an 8-tipped multichannel micropipette 722. As tactile element 118 is actuated, the processor 112 will simultaneously use its custom tactile element liquid curve 360 (see FIG. 3R2) to determine how much liquid should transfer into or out of each tip 728. If all attached tips 728 are aligned within the z and y axis thresholds, such that the points of each tip could be submerged in a liquid volume simultaneously, then the parallel tips are demonstrated to exhibit cooperative, yet independent, liquid transfer behavior. If all parallel tips 728 are all submerged simultaneously, then liquid transfer into each tip will occur according to each tip's unique tactile element liquid curve. If the parallel tips 728 are tilted such that only some are submerged while others remain under the liquid depth threshold, then only the submerged tips 728 will transfer liquid according to each tip's tactile element liquid curve 360. In one example embodiment, the non-submerged tips 728 will remain empty regardless of their tactile element liquid curve 360. Liquid uptake is dependent upon whether the tips 728 of the multichannel micropipette 722 are submerged in the liquid volume within the trough 715. The processor 112 calculates for each of the individual tips 728 as if it were an individual tip on a single channel micropipette in its own centrifuge tube 306/container 308/trough 715 (as described above in method 400). As such if the user is holding the multichannel micropipette 722 at an angle such that not all of the tips 728 are in trough 715, when the tactile element 118 is actuated the tips 728 won't interact with the liquid.

At 864, responsive to the tip activation volume 726c being within the trough activation volume 742 with the tip activation volume 726c being outside the y-axis alignment threshold, the processor 112 instructs the user display 122 to show the tips 728 filled with liquid proportional to the degree the tip activation volume 726c is outside the y axis alignment threshold. In this example embodiment, the tips 728 that are partially or unsubmerged in the liquid in the trough 715 will have less liquid present than the tips 728 that were over the liquid depth threshold. (see, for example, FIG. 7I). In one example embodiment, responsive to all the tips 729 being submerged, as liquid is taken up by the multichannel micropipette 728 the liquid volume will decrease proportionally to the liquid volume uptaken by the multichannel micropipette 728. Therefore, responsive to the tips 728 maintaining at a position and rotation and continuing to take up liquid, then some tips will begin to exit the liquid while others remain submerged. In this embodiment, there will be an unequal fill of the tips 728

At 865, responsive to the multichannel micropipette 722 trough activation volume 742 being outside the y axis alignment threshold, the processor 112 provides an error message at B-B. Continued from section line B-B in FIG. 8C, illustrated in FIG. 8E as continuing from section line B-B, steps 821 and 823 are completed. In this example embodiment, the error message includes an instruction to view the volume present in the tips 728.

At 868, responsive to the tip activation volume 726c being within the trough activation volume 742 and within the y-axis alignment threshold, the processor 112 instructs the user display 122 to show the tips 728 filled to a same volume. Continued from section line D-D in FIG. 8C, illustrated in FIG. 8D as continuing from section line D-D, at 868, and illustrated in FIGS. 7J-7L, at 868, the sensor 116 detects motion. At 870, the sensor 116 detects motion of the tip activation volume 726b of the micropipette 722 in the aliquot activation volume 752 outside the z or y axis alignment threshold. In this example embodiment, the z and y axis thresholds and the z and y axis angles 721b, 721a are relative to the alignment axis 720, which extends along one or more rows of the well plate 714 defining an axis that allows the multichannel pipette 722 to dispense liquid. In another example embodiment, the alignment axis 720 bisects a row of the well plate 714, wherein each row has its own alignment axis. In this example embodiment, the tip activation volume 726b will be assigned to the nearest alignment axis 720 during entry into the aliquot activation volume 752.

At 872, responsive to the tip activation volume 726b in the aliquot activation volume 752 being outside the z and/or y axis alignment thresholds, the processor 112 provides an error message at B-B. Continued from section line B-B in FIG. 8D, illustrated in FIG. 8E as continuing from section line B-B, steps 821 and 823 are completed. At 874, the sensor 116 detects motion of the tip activation volume 726b of the micropipette 722 in the aliquot activation volume 752 within the z and y axis alignment thresholds. At 876, responsive to the tip activation volume 726b in the aliquot activation volume 752 being inside the z and y axis alignment thresholds, the processor 112 generates an image of the multichannel micropipette 722 entering the well plate 714 in the dispensing position. In this example embodiment, the dispensing position includes a magnetic attachment of each tip 728 to a specific well plate 714 of the plurality of wells housed within the well plate along a single row. Note that the multichannel micropipette 722 has free motion to rotate itself and the tips 728 around the alignment axis 720. Stated another way, the micropipette hand controller 116 acts as “joystick” allowing the multichannel micropipette 722 to move parallel to the alignment axis 720, but not transvers to the alignment axis, or in a twisting joystick motion. (see FIGS. 7J-7J1) Outside of a defined distance (e.g., a tips' 728 height above the well plate 715) the multichannel micropipette 722 can translate along an axis perpendicular to the alignment axis 720 of the well plate 715 and magnetically snap to adjacent well plate 715 rows. In this example, once the tips 728 are visibly within a selected well row, the multichannel micropipette 722 is disallowed from translation to other rows. A clink is performed as described above in method 400, with the addition that each well of the well plate 715 is assigned its own shell of clink colliders arranged similar to the clink colliders described in method 400. As such, each individual tip 728 of the multichannel micropipette 722 is independently linkable in its respective well. Wherein, for example, some tips may undergo a clink not others if the clink technique was poorly performed.

At 878, the multichannel pipette 722 dispenses liquid as in steps 472, 476-492 of the method 400 illustrated in FIGS. 4C-4D, wherein the dispensing is occurring in the well plate 714 rather than the centrifuge tube 350.

At 882, the processor 112 determines if the tip activation volume 726c is within the waste bag activation volume 742. At 882, responsive to the tip activation volume 726c being outside the waste bag activation volume 742 and the user interacting with the tactile element 118, the processor 112 provides an error message at B-B. Continued from section line B-B in FIG. 8D, illustrated in FIG. 8E as continuing from section line B-B, steps 821 and 823 are completed. At 884, responsive to the tip activation volume 726c being inside the waste bag activation volume 742, the processor 112 receives a signal that the tactile element 118 of micropipette hand has been actuated. At 886, responsive to the processor 112 receiving a signal that the tactile element 118 of micropipette hand was actuated, the processor 112 instructs the user display 122 to show the tips 728 decoupled from the multichannel micropipette 728 and released into the waste bag 712. In this example embodiment, responsive to depression of the tactile element 118 of the controller 130 holding the micropipette 722 (e.g., the micropipette hand), then the processor 112 instructs the user display 122 show the ejection of the attached tips 328, including ejecting all attached and operating tips of any amount, simultaneously. This ejection can be done at any time in the method 700 where there are tips 728 attached to the micropipette 722. In this example embodiment, tips 728 that are new, used, full, partially filled, improperly seated are eject-able at any time.

### Capacity System of Micropipettes 322, 722

Micropipettes 322, whether single-channel 322 or multichannel 722 will be assigned by the processor 112 a “design capacity” and an “operational capacity”. Micropipette tips 328. 728 also be assigned by the processor 112 a “design capacity” which informs the processor 112 during tip application. “Design capacity” of any micropipette 322, 722 is defined as the internally tracked absolute maximum volume it is capable of drawing and dispensing accurately as the tactile element 118 is operated between the resting position 332c and the first stop 332a. (see FIG. 3R2). In one example embodiment, the processor 112 assigns the micropipette 322, 722 to have one of a 2 μL, 20 μL, 200 μL,1000 μL, or any pre-set maximum capacity. “Operational capacity” of any micropipette 322, 722 is defined as the internally tracked current maximum volume it will draw and dispense accurately as the tactile element 118 is operated between the resting position 332c and the first stop 332a. Operational capacity is less than or equal to design capacity. Design capacity of any micropipette 322, 722 restricts the range of values the processor 112 can set for the micropipette's 322, 722 operational capacity.). In one example embodiment, a micropipette 322, 722 with a 200 μL design capacity will have its operational capacity adjusted between 0 μL to 200 μL, and a micropipette 322, 722 with a 2 μL design capacity will have its operational volume adjusted between 0 μL and 2 μL. The design capacity of any micropipette 322, 722 constrains which micropipette tips 328, 728 with which design capacities (hereafter called “micropipette tip types”) that can be applied to that micropipette 322, 722.). In another example embodiment, a micropipette 322, 722 with a 1000 μL design capacity will have tips 328, 728 with a 1000 μL design capacity applied, while a micropipette 322, 722 with a 200 μL design capacity will have tips 328, 728 with either 200 μL or 20 μL design capacity applied. If the user attempts to apply an incorrect micropipette tip type to a micropipette 322, 722, then an error message instructs the user to apply correct micropipette tip types. The total capacity of the micropipette's 322, 722 tip 328, 728 liquid container is equal to 110% of the micropipette's operational capacity, this is to accommodate for the two volume deltas described above, and to allow for true-to-life forward pipetting technique. In another example embodiment, if the user picks up a micropipette 322, 722 with a 1000 μL design capacity, applies a 1000 μL micropipette tip 328, 728, then sets the micropipette's operational capacity to 800 μL then the total capacity of the micropipette's tip liquid container will internally be capable of holding 880 μL (e.g., 110%).

### Operational Capacity Adjustment of Micropipettes 322, 722

The processor 112 can adjust operational capacity at runtime, while design capacity cannot be adjusted at runtime. Events that signal the tactile element's 118 position and pressed-state (e.g., interaction with a touch pad of the controller 116 or interaction with the tactile element 118) has changed are propagated through our input by the processor 112, and the processor instructs the display to react to those touchpad change events to adjust the operational volume of the held micropipette 322. The processor 112 instructs that the operational capacity be increased as the user rotates their thumb/finger in a clockwise motion while pressing on the tactile element 118. The processor 112 instructs that the operational capacity be decreased as the user rotates their thumb/finger in a counterclockwise motion while pressing on the tactile element 118. If the user attempts to increase or decrease the operational capacity of the micropipette 322 above the design capacity or below zero capacity, respectively, then the processor 112 will instruct that an error message be presented to the user and instruct the user to not damage the micropipette 322 with excessive adjustment.

### Solution Building of Required Volumes

The processor 112 generates a laboratory environment wherein a liquid system can track the volume of different liquids that have been added together in a container to make a solution. Rather than simply knowing the types of liquids, the user can now discern what the liquid types concentration are within the mixture If the user starts with an empty container and then adds 50 uL of liquid A to it and then add an additional 100 uL of liquid B the liquid system knows that the container holds the combined volume of 150 uL of a solution that has a concentration of 1 part A to every 2 parts of B.

### Tip Contamination During Methods 400 and 800

The continuous liquid transfer described above enables contextual awareness of whether the user has successfully fully withdrawn or dispensed fluid from the tip 328. If the continuous liquid transfer as controlled by the processor 112 detects that there is a partial draw or an incomplete dispense it can ensure the user is unable to use that tip 328 in the remainder of the procedure and instruct the user to discard the tip and get a new one because a tip with a partial fill is deemed to be contaminated and therefore no longer valid for use. In one example embodiment, if the tip 328 has been withdrawn from the container 308 that it is interacting with and the volume within the tip is anything other than 0 or 100% of the operational capacity the processor 112 will infer that there was a fail partial draw or incomplete dispense.

There are several possible errors that the processor 112 will instruct be presented to the user. For example, if the partially filled tip is a consequence of the user removing the tip 328 from the liquid mid withdrawal, the user will be presented with “Keep the tip submerged while withdrawing liquid. Discard tip and start again”. If at any point a user attempts to transfer liquid with a partially filled tip 328 they will be presented with the message “Tip is partially filled; discard tip and start again.” The processor 112 will discard the volume portion that was successfully transferred, effectively restoring the target container to the state it was in prior to the attempted transfer in order to prevent the user from needing to completely discard the solution and start from the begin.

The processor 112 detects contact with the bottom of the container 308/centrifuge tube 350/trough 715/well plate 714 and determine the implied force of the contact. This is important because severe contact can cause damage to the tip 328 that will render it inaccurate and therefore contaminated for the purposes of drawing and dispensing a set volume of a liquid reliably. The processor 112 instructs that controls to be put in place that will limit the allowable amount of force that can be applied to a tip 328 before it is deemed contaminated. In one example embodiment, by calculating the deflection beyond the initial contact with the bottom of the container 308/centrifuge tube 350/trough 715/well plate 714, the processor 112 can determine how far the user is over shooting the bottom of the container 308/centrifuge tube 350/trough 715/well plate 714 and therefore how much extra force the user would be applying to the micropipette tip 328. For example, if the controller 130 is in location A when the tip 328 is determined to have reached the bottom of the container and then then controller continues to move through where the controller is by 0.25 cm or 5 cm the processor will infer that the contact that goes 5 cm is representative of significantly more pressure that would've been applied to the tip by the user pressing it 0.25 cm past the bottom of the container.

### Centrifuge Simulation 900

As illustrated in FIGS. 10A-10B, a method 1000 of use of the virtual reality system 100 with the interactive centrifuge simulation 900 is illustrated. Features of the micropipette simulation 300 illustrated in FIGS. 3A-3X that are similar to the features of the centrifuge simulation 900 illustrated in FIGS. 9A-9E will be identified by like numerals increased by six-hundred.

As illustrated in FIG. 9A, a method 900 of use of the virtual reality system 100 with the interactive centrifuge simulation 900 is illustrated. At 1002, the processor 112 receives a signal indicating the user has selected the interactive centrifuge simulation 900 (see FIG. 9A). In some example embodiments, the centrifuge simulation 900 is integrated into the micropipette simulation 300 and/or the multichannel micropipette simulation 700. At 1004, the processor 112 generates the interactive centrifuge simulation 900, including generating an image of the centrifuge 910 and instructs the user display 122 to display the centrifuge simulation.

At 1006, the processor 112 generates and instructs the user display to display an initial centrifuge view 930. The centrifuge view 930 comprises the centrifuge 910 that illustrates a centrifuge as presented in the real world. The initial centrifuge view 930 comprises the view prior to user input, and subsequent altered centrifuge views comprise the view including the user input. In another embodiment, the sensor 116 sends a signal to the processor 112 that the controller 130 is within an activation volume as described above. At 1008, the processer 112 generates and instructs the user display 122 to display centrifuge components 918. The centrifuge components 918 include one or more centrifuge tubes 950, and/or the centrifuge 910 (see, for example, FIGS. 9A-9B). Steps 1004-1010 may be performed in any order, and/or may be performed simultaneously. In this example embodiment, the centrifuge 910 includes a centrifuge lid 952, and a plurality of tube racks 932. In the example embodiment, the centrifuge components 918 are supported by a lab bench 901.

At 1010, the processor 112 designates a centrifuge activation volume 926, a centrifuge lid activation volume 952a, and/or a centrifuge loading activation volume 928 (see FIGS. 9A-9C) in Cartesian coordinate systems corresponding to the centrifuge 910, the centrifuge lid 952, and/or the centrifuge tube rack 932. In this example embodiment, the activation volumes 926, 952a, and/or 928 comprise three dimensional spatial coordinate volumes radiating out along x, y, and z axes (hereinafter “volume” unless otherwise defined) from a central location (coordinates 0,0,0) wherein the respective centrifuge component 918 is located, or a center point of the respective centrifuge component 918. In this embodiment, the activation volumes 926, and/or 952a, extend between 1 inch to about 7 inches along the x axis, between 1 inch to about 7 inches along the y axis, and/or between 1 inch to about 7 inches along the z axis, wherein the volume defined within comprises the respective activation volumes. In this embodiment, the activation volume 928, extends between 0.2inches to about 2 inches along the x axis, between 0.2 inches to about 2 inches along the y axis, and/or between 0.2 inches to about 2 inches along the z axis, wherein the volume defined within comprises the respective activation volumes. In another embodiment, the activation volumes 926, and/or 952a extend between 1 centimeter to about 3 centimeters along the x axis, between 1 centimeter to about 3 centimeters along the y axis, and/or between 1 centimeter to about 3 centimeters along the z axis, wherein the volume defined within comprises the respective activation volumes. In another embodiment, the activation volume 928 extends between 0.5 centimeter to about 2 centimeters along the x axis, between. 5 centimeter to about 2 centimeters along the y axis, and/or between.5 centimeter to about 2 centimeters along the z axis, wherein the volume defined within comprises the respective activation volumes. Distances in vertical space are based upon perceived distance by the user. In another example embodiment, the activation volume is defined as an invisible collision volume or an absolute distance from that centrifuge components 918.

At 1012, the sensor 116 detects motion. At 1014, the sensor 116 detects motion in the centrifuge activation volume 926. In this example embodiment, the centrifuge activation volume 926 engulfs a front portion of the centrifuge 910 and extends between 0.5 inches to 2 inches in front of the centrifuge 910. At 1016, responsive to the sensor 116 detecting motion in the centrifuge activation volume 926, the processor 112 generates an image showing that interaction with the centrifuge 910 is indicated. (see FIG. 9A). At 1018, the sensor 116 detects motion in the centrifuge lid activation volume 952a. Responsive to the sensor 116 detecting motion in the centrifuge lid activation volume 952a, the processor 112 generates image of the user holding the lid 952 and/or indicating that the user can interact with the lid. The sensor 116 in the centrifuge lid activation volume 952a is designated the lid hand, the sensor that is not in the centrifuge lid activation volume 952a is designated the non-lid hand.

At 1020, the user interacts with tactile element 118 of the lid hand while in the centrifuge lid activation volume 952a. At 1022, responsive to the sensor 116 detecting motion of the lid hand in the centrifuge lid activation volume 952a and interaction of the tactile element 118 with the lid hand, the processor 112 generates a display of an open centrifuge 910a (see FIG. 9B). In one example embodiment, responsive to the tactile element 118 being actuated by the lid hand in the centrifuge lid activation volume 952a, the processor 112 generates a display of the lid 952 moving in concert with movement of the sensor 116 until the lid is open and there is the open centrifuge 910a. (see FIG. 9B) At 1024, responsive to the sensor 116 detecting motion of the lid hand in the centrifuge lid activation volume 952a while the centrifuge lid 952 is open, the processor 112 generates a display of the closed centrifuge 910 (see FIG. 9A). Stated another way, as the sensor 116 detects motion in the centrifuge lid activation volume 952a, the processor 112 registers that the sensor is within centrifuge lid activation volume 952a (e.g., near a top of the centrifuge 910), indicating to the processor that the centrifuge lid 952 is being targeted to be interacted with. Responsive to the tactile element 118 being actuated while the lid hand is in the centrifuge lid activation volume 952a, the processor 112 identifies a current state of the centrifuge 910 (open or closed) and changes centrifuge's 910 state to the opposing state, either generating movement of the centrifuge 910 opening or closing, whichever is opposite of the centrifuge's initial state. In another example embodiment, the lid 950 is tethered to the sensor 116 of the lid hand, such that responsive to actuation of the tactile element 118, the lid moves in concert with the sensor to and from the open position into the closed position.

In this example embodiment, centrifuge tubes 950 have been previously prepared, and/or filled with a particular volume as described in the method 400. In this embodiment, the user enters a tube activation area (not shown) and through actuation of the tactile element 118 in the tube activation area links a centrifuge tube 950 to the sensor 116 that entered the tube activation area (e.g., the non-lid hand if one sensor is interacting with the lid 952). Stated another way, the sensor 116 coupled to the tactile element 118 that was actuated in the tube activation area is designated the tube hand.

At 1026, the sensor 130 detects motion of the tube hand in one of the centrifuge loading activation volumes 928. At 1028, the sensor 130 detects motion of a non-tube hand and/or sensor 116 that is not linked to a tube 950 in one of the centrifuge loading activation volumes 928, the processor 112 generates an error message.

At 1030, the user interacts with the tactile element 118 of the tube hand while in the first centrifuge loading activation volumes 928a. In this example embodiment, the processor 112 assigns a centrifuge loading activation volume 928 to each of the tube racks 932. (see FIG. 9C-9D). In the illustrated example embodiment of FIGS. 9C-9D, there are eight (8) tube racks 932 and eight (8) corresponding centrifuge loading activation volumes 928a-928g. At 1032, responsive to the user interacting with the tactile element 118 of the tube hand while in the first centrifuge loading activation volume 928a, the processor 112 generates a display of the centrifuge tube 950 in the first tube holder 932a. (see FIG. 9D). In one example embodiment, entry of the tube hand into the first centrifuge loading activation volume 928a will result in the processor 112 generating a display of the centrifuge tube 950 in the first tube rack 932a. (see FIG. 9D).

Continued from section line A-A in FIG. 10A, illustrated in FIG. 10B as continuing from section line A-A, at 1034, the sensor 116 detects motion. In this example embodiment, subsequently to adding the centrifuge tube 950 to the tube holder 932, the user will obtain another centrifuge tube 950 as described above, and the processor 112 will assign one of the sensors 116 as the tube hand.

At 1036, the sensor 130 detects motion of the tube hand in one of the centrifuge loading activation volumes 928. At 1038, responsive to the tube hand entering the first centrifuge loading volume 928a (where a tube 350 already resides), the processor 112 generates an error message. In this embodiment, responsive to the sensor 130 detecting motion of the non-tube hand and/or sensor 116 that is not linked to a tube 950 in one of the centrifuge loading activation volumes 928, the processor 112 generates an error message. Note, steps 1020, 1022, and 1024 may be completed with a non-tube hand at any time. Responsive to the centrifuge lid 952 being closed at any point, should a user attempt steps 1026 or 1036, the processor 112 will generate an error message.

At 1040, the user interacts with the tactile element 118 of the tube hand while in the second centrifuge loading activation volumes 928e. At 1042, responsive to the user interacting with the tactile element 118 of the tube hand while in the second centrifuge loading activation volume 928e (e.g., wherein the second centrifuge loading activation volume is directly across from the first centrifuge loading activation volume 928a), the processor 112 generates a display of the centrifuge tube 950 in the second tube holder 932e. (see FIG. 9D). In one example embodiment, entry of the tube hand into the second centrifuge loading activation volume 928e will result in the processor 112 generating a display of the centrifuge tube 950 in the second tube rack 932e. (see FIG. 9D). At 1048, the processor 112 identifies the tubes 950 as being in a balanced state. In this embodiment, the balanced state includes wherein the tubes 950 are directly across from one another, such that they will provide even weight during rotation of the centrifuge. In one example embodiment, the processor 112 determines a sum of radial coordinates in a complex plane of all occupied points of the rack 932 (e.g., a rotor circle), assuming unit radius, wherein if a complex sum is zero, then the centrifuge is balanced, if it's non-zero then the centrifuge is not balanced.

Responsive to the user interacting with the tactile element 118 of the tube hand while in the second centrifuge loading activation volume 928b, the processor 112 generates a display of the centrifuge tube 950 in the second tube rack 932b (e.g., wherein the second centrifuge loading activation volume is next to or not across from the first centrifuge loading activation volume 928a). (see FIG. 9E).

In this example embodiment, the processor 112 identifies the tubes 950 as being in an unbalanced state. In this embodiment, the unbalanced state includes wherein the tubes 950 are not directly across from one another, such that they will provide an uneven weight during rotation of the centrifuge. As illustrated in FIG. 9E, wherein the second centrifuge tube rack 932b is directly next to the first centrifuge tube rack 932a, the weight of the two centrifuge tubes 950 will cause the centrifuge rotation to be unbalanced. In another example embodiment, multiple centrifuge tubes 950 may be added to the centrifuge tube rack 932, wherein the unbalanced state is identified wherein any of the multiple centrifuge tubes 950 lack a counterweight tube directly across from any individual tube. In one example embodiment, the processor 112 allows the closing of the centrifuge lid 952 in the unbalanced state, and allows the centrifuge 910 to rotate. In this example embodiment, the unbalanced centrifuge 910 will produce excessive vibration and sliding of the centrifuge on the lab table.

At 1046, responsive to the processor 112 identifying the unbalanced state, the processor provides an error message. In one example embodiment, the processor 112 disallows closing of the centrifuge lid 952 until the unbalanced centrifuge tube 950 has been removed.

At 1050, responsive to the processor 112 identifying the balanced state, the processor 112 generates a display of balanced state (e.g., a check mark, see FIG. 9D) and allows the steps of 1016-1020 to display the closed centrifuge 910. At 1052, the processor allows the centrifuge 910 to rotate. In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. In another possible embodiment terms are defined to be within for example within 200%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A non-transitory computer readable medium storing instructions executable by an associated processor to perform a method for implementing a micropipette simulation comprising:
generating a three-dimensional initial view comprising a micropipette and one or more micropipette tips based upon a view selection input by a user;
sending instructions to present the initial view to a user display of a headset, the user display comprised within the headset;
receiving an input from a controller comprising at least one sensor indicating user movement within the initial view;
responsive to the micropipette being coupled to the controller, assigning the controller a designation of micropipette hand;
coupling a micropipette tip of the one or more micropipette tips to the micropipette;
responsive to a tip activation volume of the micropipette tip interacting with a container activation volume of a container housing a liquid, and a tactile element on the controller of the micropipette hand being actuated presenting movement of a plunger of the micropipette from a first stop to a resting position and simultaneously generating instructions to display a continuous liquid transfer from the container to the micropipette tip, wherein the speed of the continuous transfer is proportional to a speed of an actuation of the tactile element.

2. The method of claim 1, comprising generating the continuous liquid transfer based upon a tactile element liquid curve, wherein a volume of liquid is transferred from the container to the micropipette tip is proportional to a percent actuation of the tactile element.

3. The method of claim 1, comprising assigning a position of the plunger based upon a percent the tactile element of the pipette hand is actuated, wherein from five percent to forty seven percent actuation of the tactile element, the plunger is illustrated as moving from the resting position to the first stop, and between ninety percent to about ninety seven percent actuation of the tactile element, the plunger is illustrated as moving from the first stop to a second stop.

4. The method of claim 3, comprising:
dispensing about forty five percent of a total operational capacity of the micropipette in the micropipette tip at a first frame threshold responsive to the plunger moving from the resting position to a twenty five percent actuation of the tactile element;
dispensing between twelve to fourteen percent of the operational capacity in the micropipette tip at a second frame threshold, responsive to the plunger moving from the twenty five percent actuation of the tactile element to a thirty percent actuation of the tactile element; and
dispensing between forty one to forty four percent of the operational capacity from the micropipette tip at the first stop responsive to the plunger moving from the thirty percent actuation of the tactile element to a forty seven percent actuation of the tactile element, further comprising dispensing ninety five percent of the total liquid volume to be dispensed responsive to moving the plunger from the resting position to the first stop.

5. The method of claim 1, further comprising wherein the tip activation volume interacting with an activation volume of another element present in the three dimensional space, generating an image of the micropipette in a dispensing position.

6. The method of claim 1, further wherein generating the micropipette in the dispensing position comprises positioning the micropipette along a dispensing axis that is transverse to a vertical axis by between 1° to about 10°.

7. The method of claim 1, further wherein generating the micropipette in the dispensing position comprises making visible the micropipette tip in a plane with a texture that looks like a magnified view of the area.

8. The method of claim 1, comprising assigning a volume to be dispensed from the micropipette tip based upon actuating the tactile element of the pipette hand from the resting position to the first stop, and from the first stop to a second stop.

9. The method of claim 1, generating the micropipette comprising generating a multichannel pipette having two or more barrels for coupling to two or more micropipette tips, further comprising:
assigning the multichannel pipette a micropipette axis extending parallel to and intersecting the two or more barrels;
assigning a tip box interaction volume to a tip box housing two or more tips; and
assigning the tip box an alignment axis extending parallel to and intersecting the two or more tips.

10. The method of claim 9, responsive to a tip activation volume of the multichannel micropipette being within the tip box interaction volume, assigning a y-axis alignment threshold comprising a deviation over a y axis angle of the micropipette axis from the alignment axis along a y direction, wherein responsive to the tip activation volume being inside the y-axis alignment threshold, generating an image of the two or more tips attached to the two or more barrels.

11. A virtual reality system for providing a multichannel pipette simulation, the system comprising:
a processing device having a processor configured to perform a predefined set of operations in response to receiving a corresponding input from at least one of a virtual reality headset and at least one controller, the processing device comprising memory, wherein a three-dimensional initial view of a multichannel pipette simulation is stored, the initial view comprising at least one multichannel pipette supporting at least two barrels, and a tip box supporting two or more tips;
the processor instructs the initial view to be presented on a user display comprised within the headset;
the at least one controller sends an input to the processor indicating the controller is moving within the initial view;
the processor instructs the movement of the controller of the at least one controller be presented on the user display;
responsive to an input from the controller, the processor assigns the multichannel pipette be controlled by movement of the controller and designates said controller as the pipette hand;
the processor assigns a micropipette axis extending parallel to and intersecting the two or more barrels of the multichannel pipette;
the processor assigns an alignment axis extending parallel to and intersecting the two or more tips to the tip box;
responsive to the controller indicating that a tip activation volume of the multichannel micropipette is within a tip box interaction volume assigned to the tip box, the processor determines a percent deviation from a y axis alignment threshold, wherein the y-axis alignment threshold a deviation over a y axis angle of the micropipette axis from the alignment axis along a y direction; and
responsive to the tip activation volume being within the y axis alignment threshold, the processor generates an image of the two or more tips attached to the two or more barrels.

12. The system of claim 11, responsive to the controller indicating that the tip activation volume is within the tip box interaction volume, the processor determines a percent deviation from an x axis alignment threshold, wherein the x axis alignment threshold is a deviation over an x axis angle of the micropipette axis from the alignment axis along an x direction.

13. The system of claim 12, responsive to the tip activation volume being outside the x axis alignment threshold and inside the y axis threshold, the processor generates an image of the two or more barrels without tips attached.

14. The system of claim 12, responsive to the tip activation volume being within the x axis alignment threshold, the processor determines the percent deviation from the y axis alignment threshold.

15. The system of claim 14, responsive to the tip activation volume being between 1° and 15° outside of the y-axis alignment threshold, the processor generates an image of the multichannel micropipette with an incomplete tip attachment proportional to a degree the tip box interaction volume is outside y-axis alignment threshold.

16. The system of claim 14, responsive to the tip activation volume being over 15° outside of the y-axis alignment threshold, the processor generates an image of the two or more barrels without tips attached.

17. A non-transitory computer readable medium storing instructions executable by an associated processor to perform a method for implementing a centrifuge simulation comprising:
generating a three-dimensional initial view comprising a centrifuge and one or more centrifuge tubes based upon a view selection input by a user;
sending instructions to present the initial view to a user display of a headset, the user display comprised within the headset;
receiving an input from a controller comprising at least one sensor indicating user movement within the initial view;
assigning a plurality of centrifuge loading activation volumes to a plurality of tube racks housed within the centrifuge;
responsive to the controller entering an assigned centrifuge tube activation area, assigning the controller a designation of centrifuge tube hand;
responsive to the centrifuge tube hand entering a first centrifuge loading activation volume of the plurality of centrifuge loading activation volumes, generating an image of the centrifuge tube residing within the tube rack assigned to the first centrifuge loading activation volume;
responsive to the centrifuge tube hand coupled to a second centrifuge tube entering a second centrifuge loading activation volume of the plurality of centrifuge loading activation volumes, generating an image of the centrifuge tube residing within the tube rack assigned to the second centrifuge loading activation volume; and
identifying a state of the centrifuge tubes, wherein responsive to the centrifuge tubes being in a balanced state, wherein the balanced state comprises wherein the centrifuge tubes act as counter weights to each other within the tube racks, allowing the centrifuge to be actuated into rotation.

18. The method of claim 17, further comprising wherein responsive to the centrifuge tubes being in an unbalanced state, wherein the unbalanced state comprises wherein the centrifuge tubes do not act as counter weights to each other, preventing the centrifuge from rotating smoothly.

19. The method of claim 17, further comprising assigning a centrifuge lid activation volume to a lid of the centrifuge, wherein responsive to a non-centrifuge tube hand entering the centrifuge lid activation volume, tethering the lid to the controller of the non-centrifuge hand, such that the lid moves in concert with the non-centrifuge hand to and from an open position into a closed position.

20. The method of claim 17, responsive to the centrifuge tube hand being coupled to the first or second centrifuge tube and entering the first and second centrifuge loading activation volumes respectively, generating the image of the centrifuge tube residing within the tube rack assigned to the first or second centrifuge loading activation volumes, respectively, responsive to a tactile element of the centrifuge tube hand controller being actuated.
